(19) United States
(12) Patent Application Publication
(10) Pub. No.: US 2019/0266217 A1
(43) Pub. Date: Aug. 29, 2019

(54) APPARATUS AND METHOD FOR MATRIX COMPUTATION

(71) Applicant: FUJITSU LIMITED, Kawasaki-shi (JP)

(72) Inventors: Takashi Arakawa, Numazu (JP); Masafumi Yamazaki, Tachikawa (JP)

(73) Assignee: FUJITSU LIMITED, Kawasaki-shi (JP)

(21) Appl. No.: 16/251,127

(22) Filed: Jan. 18, 2019

(30) Foreign Application Priority Data
Feb. 27, 2018 (JP) 2018-033029

(51) Int. Cl. G06F 17/16; G06F 7/46; G06F 9/30

(52) U.S. Cl. CPC G06F 17/16; G06F 9/30036; G06F 7/462

(57) ABSTRACT

The number of non-zero elements is counted for each first row in a first matrix, and the maximum value therefor is determined. Pairs each containing the value and column identifier of a non-zero element are extracted from each first row, and dummy pairs are added for each first row that contains fewer non-zero elements than the maximum value, to generate compressed storage data including the same number of pairs for each first row. A second row with a row identifier corresponding to the column identifier included in each pair is extracted from a second matrix and is multiplied by the value included in the pair, to generate a row vector. By assigning an equal number of threads to each first row and summing row vectors corresponding to each first row using the assigned threads, a third matrix representing matrix multiplication between the first and second matrices is produced.

### CROSS-REFERENCE TO RELATED APPLICATION

This application is based upon and claims the benefit of priority of the prior Japanese Patent Application No. 2018-033029, filed on Feb. 27, 2018, the entire contents of which are incorporated herein by reference.

### FIELD

The embodiments discussed herein relate to an apparatus and method for matrix computation.

### BACKGROUND

Some fields of computing, such as scientific and technological computation, deal with sparse matrices. A sparse matrix is a matrix that contains many zero elements (whose values are zero) and few non-zero elements (whose values are not zero). As an internal representation of sparse matrices, a CSR (Compressed Sparse Row) format, a CSC (Compressed Sparse Column) format, or another compressed storage format may be used because a normal storage format that enumerates the values of all elements is not efficient.

In the CSR format, a non-zero element list is generated which enumerates pairs each containing the value and column index of a non-zero element. In the non-zero element list, the non-zero elements of a sparse matrix are arranged in increasing order of row indices and in increasing order of column indices within each row. That is, the non-zero element list is a one-dimensional list where zero elements are removed from the sparse matrix and the remaining non-zero elements are left-aligned and arranged in order of the non-zero elements in the first row, the non-zero elements in the second row, . . . . In addition, in the CSR format, a row list is generated which indicates where each row begins in the non-zero element list because the non-zero element list does not provide borders between the rows. The sparse matrix is represented by using the non-zero element list and row list. The CSC format is a format in which rows and columns are swapped in the CSR format, and a non-zero element list and a column list are generated.

In the fields of computing dealing with sparse matrices, a computer may perform matrix multiplication between a sparse matrix and another matrix (may be a dense matrix or a vector). In this case, the data of the sparse matrix stored in the computer may be represented in compressed storage format.

For example, there is proposed a matrix-vector multiplication system for accelerating multiplication computation between a sparse matrix and a vector. When receiving a sparse matrix in the CSR format, this proposed matrix-vector multiplication system converts the data structure of the sparse matrix from the CSR format to a JAD (Jagged Diagonal) format, and then computes the multiplication between the sparse matrix in the JAD format and the vector in parallel using a plurality of processors. The JAD format is a one-dimensional data format in which a plurality of rows in a sparse matrix are sorted in decreasing order of the number of non-zero elements, non-zero elements are extracted and left-aligned for each row, and then these non-zero elements are stored column by column in a one-dimensional array.

Further, for example, there is proposed a matrix computation method for performing multiplication between a sparse matrix in the CSR format and a vector in parallel using a plurality of processors, without converting the CSR format. Still further, for example, there is provided an information processing apparatus that stores data on each column of a sparse matrix in which the number of non-zero elements is greater than or equal to a threshold, in the JAD format, stores data on each column in which the number of non-zero elements is less than the threshold, in the CSR format, and performs the multiplication between the sparse matrix and a vector.

See, for example, Japanese Laid-open Patent Publication No. 2001-209631, Japanese Laid-open Patent Publication No. 2008-181386, and International Publication Pamphlet No. WO 2017/154946.

Consider now that a computer performs matrix multiplication between a matrix S represented in conventional compressed storage format and another matrix D to produce a matrix O. For example, it is considered that the computer computes S×D=O using the matrix S represented in conventional CSR format, as follows.

Assume now that the matrix S contains two non-zero elements in the i-th row, i.e, a non-zero element S[i, j₁] at the i-th row and j₁-th column and a non-zero element S[i, j₂] at the i-th row and j₂-th column. The computer extracts a row vector of j₁-th row from the matrix D, and multiplies each element of the extracted row vector by the value of the element S[i, j₁]. In addition, the computer extracts a row vector of j₂-th row from the matrix D, and multiplies each element of the extracted row vector by the value of the element S[i, j₂]. The sum of the two resulting row vectors corresponds to the i-th row of the matrix O. That is, the computer extracts a row vector from the matrix D and performs a multiplication on each element of the extracted row vector, with respect to each record of the non-zero element list regarding the matrix S in the CSR format, and then sums the resulting row vectors corresponding to each row of the matrix S, thereby producing the matrix O.

In addition, for example, it is now considered that the computer computes D×S=O using the matrix S represented in conventional CSC format, as follows.

Assume now that the matrix S contains two non-zero elements in the j-th column, i.e., a non-zero element S[i₁, j] at the i₁-th row and j-th column and a non-zero element S[i₂, j] at the i₂-th row and j-th column. The computer extracts a column vector of i₁-th column from the matrix D and multiplies each element of the extracted column vector by the value of the element S[i₁, j]. In addition, the computer extracts a column vector of i₂-th column from the matrix D and multiplies each element of the extracted column vector by the value of the element S[i₂, j]. The sum of the two resulting column vectors corresponds to the j-th column of the matrix O. That is, the computer extracts a column vector from the matrix D and performs a multiplication on each element of the extracted column vector, with respect to each record of the non-zero element list regarding the matrix S in the CSC format, and then sums the resulting column vectors corresponding to each column of the matrix S, thereby producing the matrix O.

It is also considered that the computer parallelizes the matrix multiplication between the matrix S and the matrix D using a plurality of threads. However, if the matrix S represented in conventional compressed storage format is used as it is, it would be inefficient to sum a plurality of vectors in parallel, and this is a problem.

For example, since the matrix S contains a different number of non-zero elements in each row, the above computation of S×D=O needs to sum a different number of row vectors with respect to each row of the matrix S. Therefore, this case would need complicated control of thread assignment for mapping threads to ranges of row vectors to be summed. Similarly, for example, since the matrix S contains a different number of non-zero elements in each column, the above computation of D×S=O needs to sum a different number of column vectors with respect to each column of the matrix S. Therefore, this case also would need complicated control of thread assignment for mapping threads to ranges of column vectors to be summed.

### SUMMARY

According to one aspect, there is provided a matrix computation apparatus that includes: a memory configured to store therein a program; and a processor configured to be able to execute a plurality of threads in parallel according to the program, wherein the processor, when executing the program, performs a process including counting a number of non-zero elements, whose values are not zero, for each of a plurality of first rows included in a first matrix and determining a maximum value for the number of non-zero elements among the plurality of first rows, generating compressed storage data containing an equal number of pairs for each of the plurality of first rows by extracting, from each of the plurality of first rows, a pair containing a value of a non-zero element and a column identifier identifying a column to which the non-zero element belongs and adding a dummy pair with a value of zero for each first row that contains fewer non-zero elements than the maximum value, generating a row vector corresponding to each of the pairs contained in the compressed storage data by extracting, from a second matrix, a second row with a row identifier corresponding to the column identifier included in the each of the pairs and multiplying the extracted second row by the value included in the each of the pairs, and generating a third matrix representing matrix multiplication between the first matrix and the second matrix by assigning an equal number of threads to each of the plurality of first rows and summing row vectors corresponding to the each of the plurality of first rows using the equal number of threads.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a view for explaining an example of a matrix computation apparatus;

FIG. 2 is a block diagram illustrating an example of a hardware configuration of an information processing apparatus;

FIG. 3 is a block diagram illustrating an example of a software configuration of the information processing apparatus;

FIG. 4 illustrates an example of matrix multiplication;

FIG. 5 illustrates an example of first CSR data;

FIG. 6 illustrates an example of matrix multiplication using the first CSR data;

FIG. 7 illustrates an example of an aggregation process in first matrix multiplication;

FIG. 8 illustrates an example of thread assignment in a first aggregation process;

FIG. 9 is a flowchart illustrating an example of how to generate the first CSR data;

FIG. 10 is a flowchart illustrating an example of how to perform the first matrix multiplication;

FIG. 11 is a continuation flowchart of the flowchart started in FIG. 10;

FIG. 12 illustrates an example of second CSR data;

FIG. 13 illustrates an example of matrix multiplication using the second CSR data;

FIG. 14 illustrates an aggregation process in second matrix multiplication;

FIG. 15 illustrates an example of thread assignment in a second aggregation process;

FIG. 16 is a flowchart illustrating an example of how to generate the second CSR data;

FIG. 17 is a continuation flowchart of the flowchart started in FIG. 16;

FIG. 18 is a flowchart illustrating an example of the second matrix multiplication; and

FIG. 19 is a continuation flowchart of the flowchart started in FIG. 18.

### DESCRIPTION OF EMBODIMENTS

Hereinafter, preferred embodiments will be described with reference to the accompanying drawings.

### First Embodiment

A first embodiment will now be described.

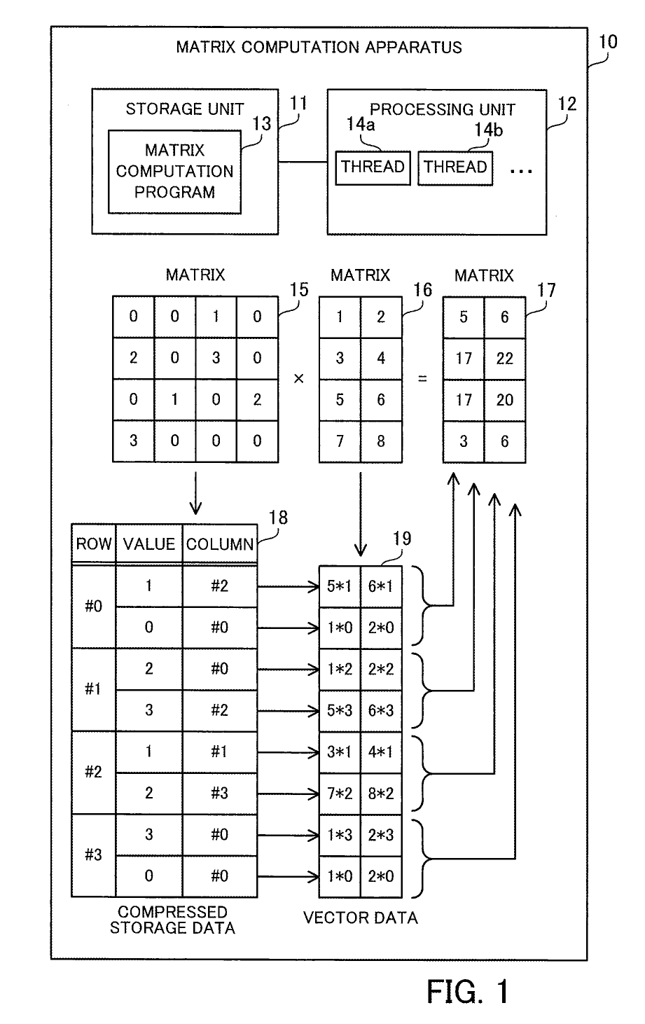

FIG. 1 is a view for explaining an example of a matrix computation apparatus.

The matrix computation apparatus 10 of the first embodiment is a computer that computes matrix multiplication between two matrices. The matrix computation apparatus 10 may be used for scientific and technological computation that deals with large-scale sparse matrices. The matrix computation apparatus 10 may be a client computer or a server computer. The matrix computation apparatus 10 includes a storage unit 11 and a processing unit 12.

The storage unit 11 stores therein a matrix computation program 13. The matrix computation program causes the processing unit 12 to perform matrix multiplication, as will be described later. The matrix computation program 13 may be a user program created by a user, a program created by converting a user program with a compiler, a linker, or another translation software, or a library program that is called from a user program. The storage unit 11 may be a volatile semiconductor memory device, such as a RAM (Random Access Memory), or a non-volatile storage device, such as an HDD (Hard Disk Drive) or a flash memory.

The processing unit 12 runs the matrix computation program 13 stored in the storage unit 11. The processing unit 12 includes a plurality of operating units that are able to execute a plurality of threads in parallel. The plurality of operating units may be processor cores or relatively small operating circuits such as ALUs (Arithmetic Logic Units). The processing unit 12 may be a CPU (Central Processing Unit), a GPU (Graphics Processing Unit), a GPGPU (General Purpose Computing on GPU), or a DSP (Digital Signal Processor). The processing unit 12 may include a large number of operating units ranging from several thousands to several tens of thousands, and may be designed to be able to execute a large number of threads ranging from several thousands to several tens of thousands in parallel using the large number of operating units. The processing unit 12 starts and executes a plurality of threads including threads 14a and 14b for matrix multiplication, to be described later, according to the matrix computation program 13.

The processing unit 12 running the matrix computation program 13 produces a matrix 17 (third matrix, matrix O) representing the matrix multiplication between a matrix 15 (first matrix, matrix S) and a matrix 16 (second matrix, matrix D), from these matrices 15 and 16. The matrix 15 is a large-scale sparse matrix with a large number of rows and a large number of columns, which contains relatively few non-zero elements and relatively many zero elements. The non-zero elements are elements whose values are not zero, whereas the zero elements are elements whose values are zero. The matrix may be a square matrix. The matrix computation apparatus 10 holds the data of the matrix 15 in a format that is an extension of a compressed storage format (compressed row storage format or compressed column storage format), as will be described later. The matrix is usable in the matrix multiplication with the matrix 15. That is, at least the number of rows or columns in the matrix 16 equals the number of columns or rows in the matrix 15, respectively. The matrix 16 may be a dense matrix, which contains relatively many non-zero elements and relatively few zero elements. The matrix computation apparatus 10 may hold the data of the matrix 16, without using the compressed storage format.

The following describes the case of representing the matrix 15 using an extension of the compressed row storage format and performing a matrix multiplication of S×D=O. Therefore, in the following example, the number of columns in the matrix 15 equals the number of rows in the matrix 16. As will be described later, in the case where the matrix 15 is represented using an extension of the compressed column storage format, a matrix multiplication of D×S=O is achieved by swapping rows and columns in the matrix multiplication of S×D=O. In addition, since D×S=(S^{T}×D^{T})^{T} is satisfied, D×S=O may be computed in the same way as S×D=O, using the transposed matrices of the matrices 15 and 16. In this case, the number of columns in the matrix 16 equals the number of rows in the matrix 15.

The processing unit 12 counts the number of non-zero elements in each row of the matrix 15, and determines the maximum value for the number of non-zero elements among the plurality of rows. FIG. 1 illustrates an example of the matrix 15 with four rows and four columns for simple explanation. Among the elements of the matrix 15, the following elements are non-zero elements: S[0,2], S[1,0], S[1,2], S[2,1], S[2,3], and S[3,0]. That is, the number of non-zero elements in the row #0 is one. The number of non-zero elements in the row #1 is two, the number of non-zero elements in the row #2 is two, and the number of non-zero elements in the row #3 is one. Therefore, the maximum value for the number of non-zero elements among the rows #0 to #3 is two. In this connection, both the row and the column indices start with zero.

Then, the processing unit 12 generates compressed storage data 18 representing the matrix 15. The processing unit 12 may generate the compressed storage data 18 from two-dimensional structure data, which is represented without using the compressed storage format, or may generate the compressed storage data 18 by converting data represented using a normal compressed storage format, such as a compressed row storage format. In the former case, the processing unit 12 receives the two-dimensional structure data. In the latter case, the processing unit 12 receives the data in the normal compressed storage format.

At this time, the processing unit 12 extracts, from each row of the matrix 15, pairs each containing the value of a non-zero element and a column identifier (for example, column index) identifying a column to which the non-zero element belongs. The processing unit 12 registers the extracted pairs in the compressed storage data 18. In this connection, the processing unit 12 adds dummy pairs each containing a value of zero with respect to each row that has fewer non-zero elements than the maximum value such that the compressed storage data 18 has the same number of pairs in each row of the matrix 15. That is, the number of pairs is equalized among the rows in the compressed storage data 18. For example, the number of pairs registered in each row is equal to the maximum value determined as above for the number of non-zero elements. A desired column identifier may be used as a column identifier to be included in the dummy pairs. For example, a column identifier identifying a column #0 is used. In this connection, the values of non-zero elements and the corresponding column identifiers may be managed, not using the same data table but using different data tables or different arrays, as long as the value of each non-zero element and its corresponding column identifier are associated with each other.

In the above-described example illustrated in FIG. 1, a pair of (1, column #2) is extracted from the row #0 as a pair of (value, column identifier). Since the number of non-zero elements in the row #0 is less than the maximum value, a dummy pair of (0, column #0) is added. Pairs of (2, column #0) and (3, column #2) are extracted from the row #1. Since the number of non-zero elements in the row #1 is equal to the maximum value, no dummy pair is added. Pairs of (1, column #1) and (2, column #3) are extracted from the row #2. Since the number of non-zero elements in the row #2 is equal to the maximum value, no dummy pair is added. A pair of (3, column #0) is extracted from the row #3. Since the number of non-zero elements in the row #3 is less than the maximum value, a dummy pair of (0, column #0) is added. By doing so, the number of pairs is equalized to two among the rows in the compressed storage data 18.

After that, with respect to each pair included in the compressed storage data 18, the processing unit 12 extracts a row with a row identifier (for example, a row index that is equal to the column index) corresponding to the column identifier included in the pair, and then multiplies each element of the extracted row by the value included in the pair. By doing so, a row vector is generated for each pair included in the compressed storage data 18. The processing unit 12 enumerates the generated row vectors into vector data 19. The processing unit 12 may parallelize the generation of the vector data 19 using a plurality of threads. For example, the processing unit 12 assigns different threads to the generation of row vectors corresponding to different pairs.

In the above-described example illustrated in FIG. 1, with respect to the row #0 of the matrix 15, a row vector is generated by extracting the row #2 of the matrix 16 and multiplying each element thereof by one, and a row vector is generated by extracting the row #0 of the matrix 16 and multiplying each element thereof by zero. With respect to the row #1 of the matrix 15, a row vector is generated by extracting the row #0 of the matrix 16 and multiplying each element thereof by two, and a row vector is generated by extracting the row #2 of the matrix 16 and multiplying each element thereof by three. With respect to the row #2 of the matrix 15, a row vector is generated by extracting the row #1 of the matrix 16 and multiplying each element thereof by one, and a row vector is generated by extracting the row #3 of the matrix 16 and multiplying each element thereof by two. With respect to the row #3 of the matrix 15, a row vector is generated by extracting the row #0 of the matrix 16 and multiplying each element thereof by three, and a row vector is generated by extracting the row #0 of the matrix 16 and multiplying each element thereof by zero.

Since the dummy pairs have a value of zero, the row vectors corresponding to the dummy pairs are zero vectors with all zero elements. It is preferable that row vectors be generated with respect to dummy pairs in the same way as the other pairs, in order to streamline control of the parallel processing.

Then, the processing unit 12 assigns an equal number of threads to each row of the matrix 15. That is, the number of threads to be assigned is equalized among the rows of the matrix 15. The number of threads to be assigned to each row is determined based on the number of pairs per row of the compressed storage data 18 and the number of columns in the matrix 16 (that is, the number of columns in each row vector). As an example, a value obtained by dividing the number of pairs per row by two, rounding the resultant down to the nearest integer, and multiplying the integer by the number of columns in the matrix 16 is taken as the number of threads to be assigned to each row. In the above-described example illustrated in FIG. 1, since the number of pairs per row is two and the number of columns in the matrix 16 is two, the number of threads to be assigned to each row is calculated to be two. As a result, two threads are assigned to each row of the matrix 15.

Then, with respect to each row of the matrix 15, the processing unit 12 parallelizes the sum of the row vectors corresponding to the row using the threads assigned to the row. Since as many row vectors as the number of pairs per row are already generated with respect to each row of the matrix 15, the values of elements in the same column in the row vectors are added. To sum four or more row vectors, for example, a sum of two row vectors is hierarchically repeated according to the binary tree approach. A sum of two row vectors and a sum of other two row vectors are performed using different threads in parallel. In addition, in two row vectors, an addition of values of a column and an addition of values of another column are performed using different threads in parallel. At this time, it is preferable to include zero vectors generated from dummy pairs in performing such sums in the same way as the other row vectors, in order to streamline the control of the parallel processing.

Then, the processing unit 12 uses a result of summing row vectors corresponding to each row of the matrix 15 as a row of the matrix 17 corresponding to the row of the matrix 15. By doing so, the processing unit produces the matrix 17 representing the matrix multiplication of the matrix 15 by the matrix 16. In the sum of row vectors, appropriate row vectors of the vector data 19 may be rewritten, using a storage space storing the vector data 19. This eliminates the need of using a different storage space for summing two row vectors. In the case of summing row vectors within the storage space storing the vector data 19, the row vectors corresponding to the final sum results are extracted from the vector data 19 and then the matrix 17 is produced. Alternatively, a view for viewing only the appropriate row vectors of the vector data 19 may be defined, instead of preparing a storage space for the matrix 17 different from the storage space for the vector data 19. This enables the application to view a subset of the vector data 19 as the matrix 17.

In the above-described example illustrated in FIG. 1, two row vectors corresponding to the row #0 of the matrix 15 are summed to generate the row #0 of the matrix 17. In this connection, one of these two row vectors is a zero vector. Two row vectors corresponding to the row #1 of the matrix 15 are summed to generate the row #1 of the matrix 17. Two row vectors corresponding to the row #2 of the matrix 15 are summed to generate the row #2 of the matrix 17. Two row vectors corresponding to the row #3 of the matrix 15 are summed to generate the row #3 of the matrix 17. In this connection, one of these two row vectors is a zero vector. In this way, it is possible to execute all threads, each for summing row vectors, in the same way, even though the vector data 19 includes two zero vectors.

The above example has described the matrix multiplication of S×D=O. The matrix multiplication of D×S=O may be achieved by swapping rows and columns.

More specifically, the processing unit 12 counts the number of non-zero elements in each column of the matrix 15, and then determines the maximum value for the number of non-zero elements. The processing unit 12 extracts pairs each containing the value of a non-zero element and a row identifier from each column of the matrix 15, and adds dummy pairs with a value of zero, with respect to each column that has fewer non-zero elements than the maximum value, to thereby generate compressed storage data 18 including the same number of pairs in each column of the matrix 15. Then, with respect to each pair included in the compressed storage data 18, the processing unit 12 extracts, from the matrix 16, a column with a column identifier corresponding to the row identifier included in the pair, and multiplies each element of the extracted column by the value included in the pair, to thereby generate a column vector. The processing unit 12 enumerates the generated column vectors into vector data 19. The processing unit 12 assigns an equal number of threads to each column of the matrix 15, and sums the column vectors corresponding to the column using the assigned threads, to thereby produce a matrix 17 representing the matrix multiplication of the matrix 16 by the matrix 15.

The matrix computation apparatus 10 of the first embodiment adds dummy pairs with a value of zero to the compressed storage data 18 so as to equalize the number of pairs among the rows of the matrix 15 (or among the columns of the matrix 15). Thereby, the same number of row vectors are generated for each row of the matrix 15 (or the same number of column vectors are generated for each column of the matrix 15). Therefore, it becomes easy to map threads to ranges of row vectors to be summed (or ranges of column vectors to be summed), which leads to streamlining the control of the parallel processing for summing row vectors (or for summing column vectors). As a result, the parallel processing for the matrix multiplication becomes efficient.

### Second Embodiment

A second embodiment will now be described.

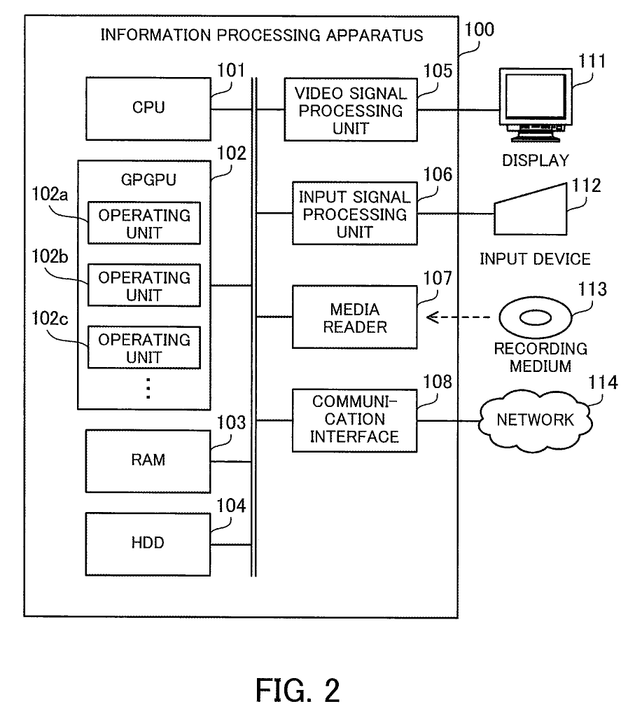

FIG. 2 is a block diagram illustrating an example of a hardware configuration of an information processing apparatus.

The information processing apparatus 100 of the second embodiment computes matrix multiplication between a large-scale sparse matrix and a dense matrix. The information processing apparatus 100 includes a CPU 101, a GPGPU 102, a RAM 103, an HDD 104, a video signal processing unit 105, an input signal processing unit 106, a media reader 107, and a communication interface 108. These units are connected to a bus. In this connection, the RAM 103 or HDD 104 corresponds to the storage unit 11 of the first embodiment. The GPGPU 102 corresponds to the processing unit 12 of the first embodiment.

The CPU 101 is a processor including an operating circuit for executing program instructions. The CPU 101 loads at least part of a program and data from the HDD 104 to the RAM 103, and executes the program. The CPU 101 may control the GPGPU 102 to perform matrix multiplication.

The GPGPU 102 is a processor that uses a GPU, which has an operating unit designed for graphics processing, for another purpose. The GPGPU 102 has a large number of operating units including operating units 102a, 102b, and 102c that are able to execute threads in parallel. These operating units may be processor cores or relatively small unit circuits, such as ALUs. For example, the GPGPU 102 has a large number of operating units ranging from several thousands to several tens of thousands so as to execute a large number of threads in parallel.

The RAM 103 is a volatile semiconductor memory device for temporarily storing therein programs to be executed by the CPU 101 and GPGPU 102 and data to be used for computation. Note that the information processing apparatus 100 may be provided with a different type of memory other than RAM, or may be provided with a plurality of memory devices.

The HDD 104 is a non-volatile storage device to store therein software programs, such as an OS (operating system) and middleware, and data. Note that the information processing apparatus 100 may be provided with a different type of storage device, such as a flash memory or an SSD (Solid State Drive), or may be provided with a plurality of non-volatile storage devices.

The video signal processing unit 105 outputs images to the display 111 connected to the information processing apparatus 100 in accordance with commands from the CPU 101. The display 111 may be any type of display, such as a CRT (Cathode Ray Tube) display, an LCD (Liquid Crystal Display), a plasma display, or an OEL (Organic Electro-Luminescence) display.

The input signal processing unit 106 receives an input signal from an input device 112 connected to the information processing apparatus 100 and supplies the input signal to the CPU 101. Various types of input devices may be used as the input device 112, for example, a pointing device, such as a mouse, a touch panel, a touchpad, or a trackball, a keyboard, a remote controller, or a button switch. A plurality of types of input devices may be connected to the information processing apparatus 100.

The media reader 107 is a reading device for reading programs and data from a recording medium 113. The recording medium 113 may be, for example, a magnetic disk, an optical disc, a MO (Magneto-Optical disk), or a semiconductor memory device. Examples of magnetic disks include FDs (Flexible Disks) and HDDs. Examples of optical discs include CDs (Compact Discs) and DVDs (Digital Versatile Discs).

The media reader 107 copies the programs and data read out from the recording medium 113 to a different recording medium, for example, the RAM 103 or the HDD 104. The read programs are executed, for example, by the CPU 101 or GPGPU 102. Note that the recording medium 113 may be a portable recording medium and used to distribute the programs and data. In addition, the recording medium 113 and the HDD 104 are sometimes referred to as computer-readable recording media.

The communication interface 108 is connected to a network 114 and communicates with other information processing apparatuses over the network 114. The communication interface 108 may be a wired communication interface that is connected to a wired communication device, such as a switch, via a cable, or a wireless communication interface that is connected to a base station via a wireless link.

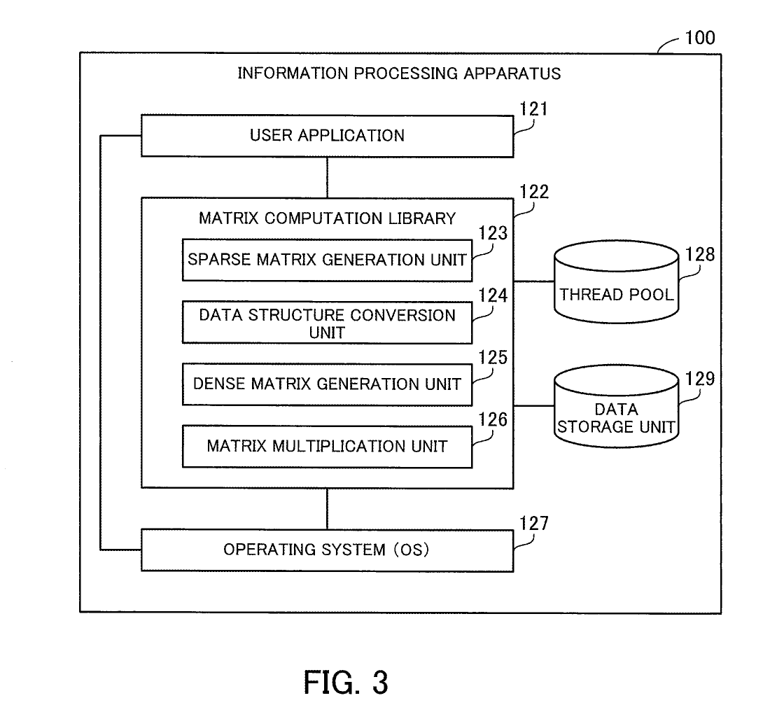

FIG. 3 is a block diagram illustrating an example of a software configuration of the information processing apparatus.

The information processing apparatus 100 includes a user application 121, a matrix computation library 122, an operating system 127, a thread pool 128, and a data storage unit 129. The user application 121, matrix computation library 122, and operating system 127 are implemented by using programs. The thread pool 128 and data storage unit 129 are implemented by using a storage space in the RAM 103, for example.

The user application 121 is application software that is implemented by using a user program created by a user. The user application 121 calls the matrix computation library 122 with a sparse matrix and a dense matrix specified, to cause the matrix computation library 122 to perform matrix multiplication between the sparse matrix and the dense matrix, and then obtains the result of the matrix multiplication.

The matrix computation library 122 is library software that is implemented by using a program for computing matrix multiplication. The matrix computation library 122 is linked with the user application 121, which calls the matrix computation library 122. The matrix computation library 122 may be a static link library or a dynamic link library. The static link library is statically linked with the user application 121 when the user application 121 is created, whereas the dynamic link library is dynamically linked therewith when the user application 121 is executed. The matrix computation library 122 may be incorporated in the user application 121, which is then distributed.

The matrix computation library 122 causes the GPGPU 102 to execute a plurality of threads in parallel, in order to accelerate matrix multiplication computation. The matrix computation library 122 includes a sparse matrix generation unit 123, a data structure conversion unit 124, a dense matrix generation unit 125, and a matrix multiplication unit 126.

The sparse matrix generation unit 123 generates a sparse matrix in the form of two-dimensional structure data by arranging all elements of the sparse matrix, including zero elements, in a two-dimensional array, in accordance with inputs from the user application 121. The data structure conversion unit 124 converts the two-dimensional structure data generated by the sparse matrix generation unit 123 into CSR data based on the idea of a compressed row storage format. As will be described later, as the CSR data, first CSR data based on the normal compressed row storage format and second CSR data based on an extension of the compressed row storage format may be generated.

The dense matrix generation unit 125 generates a dense matrix in the form of two-dimensional structure data by arranging all elements of the dense matrix in a two-dimensional array, in accordance with inputs from the user application 121. The matrix multiplication unit 126 produces an output matrix that is a result of the matrix multiplication between the sparse matrix and the dense matrix, using the CSR data generated by the data structure conversion unit 124 and the two-dimensional structure data of the dense matrix generated by the dense matrix generation unit 125. This output matrix is two-dimensional structure data in which all elements of the output matrix are stored in a two-dimensional array. As will be described later, a different method is employed for the matrix multiplication according to the format of the CSR data. The matrix multiplication unit 126 outputs the output matrix to the user application 121.

The operating system 127 receives user inputs made using the input device 112, and exercises control according to the user inputs. To create the user application 121, the information processing apparatus 100 may include development software, such as a compiler or a linker. For example, the compiler compiles a source code to generate an object code according to the user inputs received by the operating system 127, and the linker links the object code with the matrix computation library 122. By doing so, the user application 121 linked with the matrix computation library 122 is created.

In this connection, an executable program equivalent to the user application 121 may be created by another information processing apparatus and entered to the information processing apparatus 100. In addition, in the second embodiment, an algorithm for matrix multiplication is described in the matrix computation library 122. Alternatively, the user may directly write the algorithm in a source code. Even if the algorithm is not described in the source code, the compiler is able to directly insert the algorithm in the object code.

The thread pool 128 is a pool of a plurality of threads that have previously been activated. These threads are executable in parallel using a plurality of operating units provided in the GPGPU 102. By previously activating the plurality of threads, it becomes possible to reduce an overhead in activating the threads in the middle of matrix multiplication. The plurality of threads are activated by the matrix computation library 122. In addition, the plurality of threads are used for matrix multiplication by the matrix multiplication unit 126.

The data storage unit 129 stores therein the two-dimensional structure data of a sparse matrix generated by the sparse matrix generation unit 123, CSR data generated by the data structure conversion unit 124, and the two-dimensional structure data of a dense matrix generated by the dense matrix generation unit 125. In addition, the data storage unit 129 stores therein intermediate data generated by the matrix multiplication unit 126 in the middle of matrix multiplication and the two-dimensional structure data of an output matrix generated by the matrix multiplication unit 126. Also, the data storage unit 129 stores therein various kinds of control information including information indicating assignment of threads held in the thread pool 128.

The matrix computation library 122 is able to perform one or both of first matrix multiplication using the first CSR data as the data structure of a sparse matrix and second matrix multiplication using the second CSR data as the data structure of the sparse matrix. In the case where the matrix computation library 122 is able to perform both of them, the user may be allowed to select a matrix multiplication method. The following first describes the first matrix multiplication and then the second matrix multiplication.

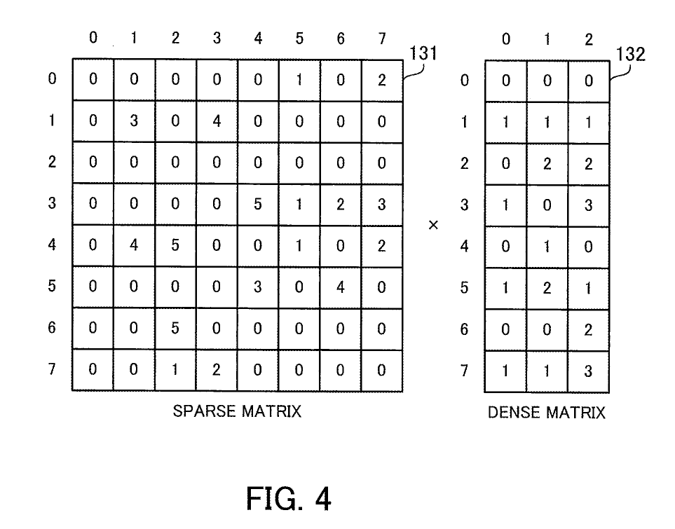

FIG. 4 illustrates an example of matrix multiplication.

The second embodiment describes matrix multiplication using a sparse matrix 131 (sparse matrix S_{2D}) and a dense matrix 132 (dense matrix D) that are relatively compact, as illustrated in FIG. 4.

The sparse matrix 131 is an 8-by-8 matrix with many zero elements. The row indices of the sparse matrix 131 are given #0, #1, . . . , and #7 in order from the top row to the bottom row. The column indices of the sparse matrix 131 are given #0, #1, . . . , and #7 in order from the left column to the right column.

In the sparse matrix 131, the following elements are non-zero elements: [0,5], [0,7], [1,1], [1,3], [3,4], [3,5], [3,6], [3,7], [4,1], [4,2], [4,5], [4,7], [5,4], [5,6], [6,2], [7,2], and [7,3]. The other elements in the sparse matrix 131 are zero elements. That is, out of the 64 elements in the sparse matrix 131, only these 17 elements are non-zero elements.

The dense matrix 132 is an 8-by-3 matrix with few zero elements. The row indices of the dense matrix 132 are given #0, #1, . . . , and #7 in order from the top row to the bottom row. The column indices of the dense matrix 132 are given #0, #1, and #2 in order from the left column to the right column.

In this connection, in the second embodiment, the sparse matrix S_{2D} is represented in compressed row storage format or another format that is an extension thereof, and then S_{2D}×D is computed. Alternatively, the sparse matrix S_{2D} may be represented in compressed column storage format or another format that is an extension thereof, and then D×S_{2D} may be computed. In this case, this multiplication is achieved by swapping rows and columns in an algorithm that will be described later. Further, since D×S_{2D}=(S_{2D}^{T}×D^{T})^{T} is satisfied, D×S_{2D} is computed by transposing each of the sparse matrix S_{2D} and dense matrix D and then transposing the produced output matrix.

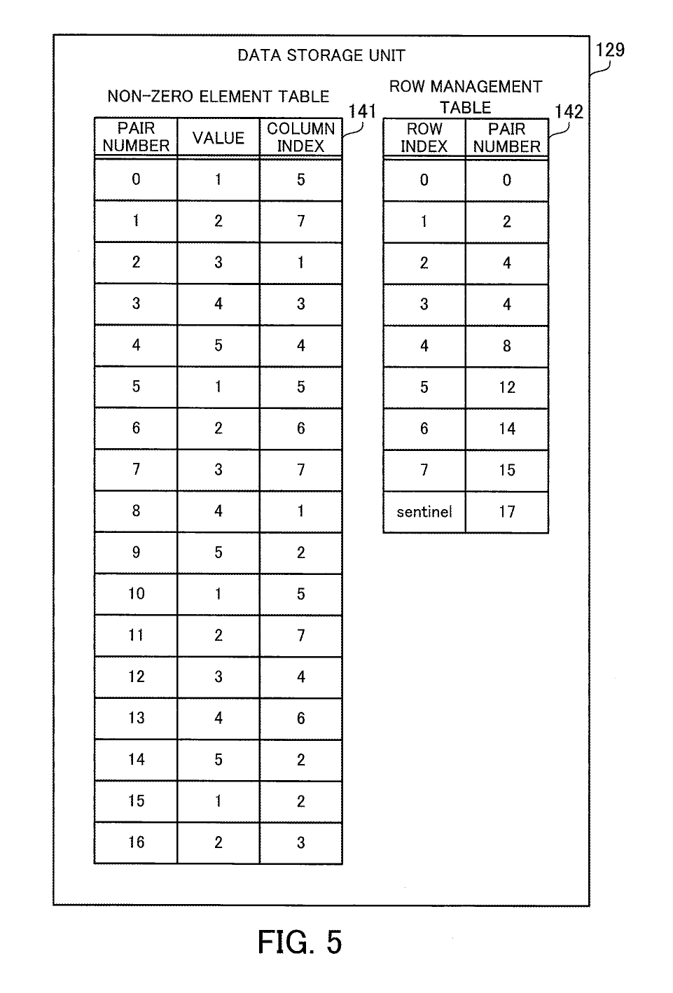

FIG. 5 illustrates an example of first CSR data.

In the first matrix multiplication, a non-zero element table 141 (non-zero element table S_{E}) and a row management table 142 (row management table S_{R}) are generated from the sparse matrix 131. These non-zero element table 141 and row management table 142 are stored in the data storage unit 129.

The non-zero element table 141 has the following fields: Pair Number, Value, and Column Index. The Pair Number field contains a sequential integer starting with zero, which identifies a non-zero element included in the sparse matrix 131. The Value field contains the value of the corresponding non-zero element. The Column Index field contains a column index identifying a column to which the corresponding non-zero element belongs. The plurality of non-zero elements are listed in the non-zero element table 141 in increasing order of row indices and in increasing order of column indices within each row. In this connection, the non-zero element table 141 does not need to have the Pair Number field explicitly, as long as the non-zero elements are identifiable.

The row management table 142 indicates where each row begins in the non-zero element table 141. This is because the non-zero element table 141 contains information identifying a column to which an individual non-zero element belongs, but does not contain information identifying rows. The row management table 142 has the following fields: Row index and Pair Number. The Row Index field contains a row index identifying a row in the sparse matrix 131. The Pair Number field contains the pair number of the first non-zero element in the corresponding row in the non-zero element table 141. In this connection, a row without any non-zero elements is associated with a pair number identifying the next non-zero element. In addition, a record having a row index of “sentinel” and a pair number of a value greater by one than the maximum value for pair number is registered at the end of the row management table 142 to clarify the end.

For example, in the non-zero element table 141, pair numbers 0 to 16 are given to the 17 non-zero elements included in the sparse matrix 131. In the row management table 142, the row #0 is associated with the pair number 0 identifying the first non-zero element in the row #0. Similarly, the row #1 is associated with the pair number 2 identifying the first non-zero element in the row #1. Since the row #2 does not contain any non-zero elements, the row #3 is associated with the pair number 4 identifying the first non-zero element in the row #3 and the row #2 is also associated with the pair number 4. The row #4 is associated with the pair number 8 identifying the first non-zero element in the row #4. The row #5 is associated with the pair number 12 identifying the first non-zero element in the row #5. The row #6 is associated with the pair number 14 identifying the first non-zero element in the row #6. The row #7 is associated with the pair number 15 identifying the first non-zero element in the row #7. In addition, a record associating “sentinel” with the pair number 17 is registered at the end of the row management table 142.

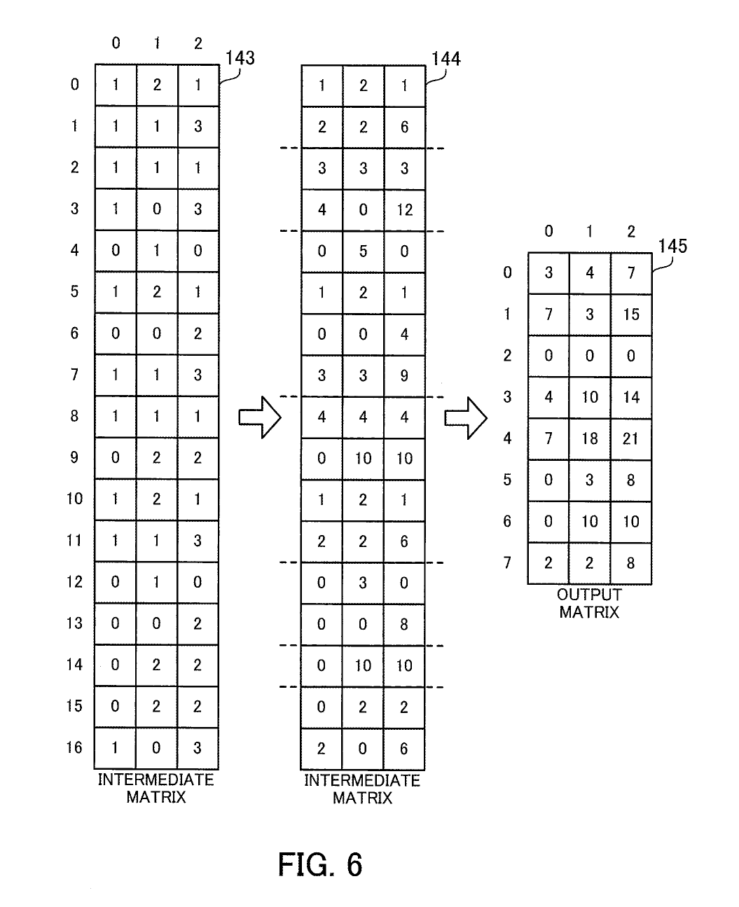

FIG. 6 illustrates an example of matrix multiplication using the first CSR data.

In the case where the sparse matrix 131 is represented by using the non-zero element table 141 and the row management table 142, the matrix multiplication unit 126 is able to perform matrix multiplication as follows. As will be described below, the computation of the matrix multiplication is divided into a copy process as a first process, a multiplication process as a second process, and an aggregation process as a third process.

In the copy process, the matrix multiplication unit 126 generates an intermediate matrix 143 on the basis of the non-zero element table 141. The intermediate matrix 143 is stored in the data storage unit 129. The intermediate matrix 143 is a two-dimensional matrix in which the number of rows equals the number of records included in the non-zero element table 141, i.e., the number of non-zero elements in the sparse matrix 131, and the number of columns equals the number of columns in the dense matrix 132.

The matrix multiplication unit 126 extracts a column index from the non-zero element table 141, extracts a row whose row index is equal to the extracted column index from the dense matrix 132, and stores the extracted row in the intermediate matrix 143. In this case, the order of rows in the intermediate matrix 143 matches the order of column indices in the non-zero element table 141. For example, with respect to the column #5 corresponding to the pair number 0, the matrix multiplication unit 126 extracts the row #5 from the dense matrix 132 and copies it to the row #0 of the intermediate matrix 143. In addition, with respect to the column #7 corresponding to the pair number 1, the matrix multiplication unit 126 extracts the row #7 from the dense matrix 132 and copies it to the row #1 of the intermediate matrix 143. In this way, the matrix multiplication unit 126 extracts 17 rows from the dense matrix 132 on the basis of the column indices corresponding to the pair numbers 0 to 16.

In the multiplication process, the matrix multiplication unit 126 generates an intermediate matrix 144 from the intermediate matrix 143. The intermediate matrix 144 is an update of the intermediate matrix 143. If the intermediate matrix 144 is generated by overwriting the intermediate matrix 143, a storage space different from where the intermediate matrix 143 is stored does not need to be used.

The matrix multiplication unit 126 extracts a value from the non-zero element table 141 and multiplies each element of the corresponding row in the intermediate matrix 143 by the value. For example, the matrix multiplication unit 126 multiplies each element of the row #0 in the intermediate matrix 143 by the value “1” corresponding to the pair number 0 (that is, the value of each element is increased by one-fold). In addition, the matrix multiplication unit 126 multiplies each element of the row #1 in the intermediate matrix 143 by the value “2” corresponding to the pair number 1 (the value of each element is increased by two-fold). In this way, the matrix multiplication unit 126 performs multiplications between the values in the rows #0 to #16 of the intermediate matrix 143 and the values corresponding to the corresponding pair numbers 0 to 16.

In the aggregation process, the matrix multiplication unit 126 groups rows of the intermediate matrix corresponding to each row of the sparse matrix 131, and sums the grouped rows to thereby produce an output matrix 145. The output matrix 145 is stored in the data storage unit 129. The output matrix 145 is a two-dimensional matrix in which the number of rows equals the number of rows in the sparse matrix 131 and the number of columns equals the number of columns in the dense matrix 132.

With respect to each row of the sparse matrix 131, the matrix multiplication unit 126 specifies a range of rows in the intermediate matrix 144 generated from the non-zero elements appearing in the row of the sparse matrix 131, and adds up the values for each column in the specified range of rows. The total values are taken as the values in a row of the output matrix corresponding to the row of the sparse matrix 131. For example, the matrix multiplication unit 126 specifies the rows #0 and #1 of the intermediate matrix 144 corresponding to the row #0 of the sparse matrix 131, and sums the two rows to thereby obtain the row #0 of the output matrix 145. In addition, the matrix multiplication unit 126 specifies the rows #2 and #3 of the intermediate matrix 144 corresponding to the row #1 of the sparse matrix 131, and sums the two rows to thereby obtain the row #1 of the output matrix 145. Since the intermediate matrix 144 does not have any rows corresponding to the row #2 of the sparse matrix 131, all elements in the row #2 of the output matrix 145 are zero.

In addition, the matrix multiplication unit 126 specifies the rows #4 to #7 of the intermediate matrix 144 corresponding to the row #3 of the sparse matrix 131, and sums the four rows to thereby obtain the row #3 of the output matrix 145. In addition, the matrix multiplication unit 126 specifies the rows #8 to #11 of the intermediate matrix 144 corresponding to the row #4 of the sparse matrix 131, and sums the four rows to thereby obtain the row #4 of the output matrix 145. Further, the matrix multiplication unit 126 specifies the rows #12 and #13 of the intermediate matrix 144 corresponding to the row #5 of the sparse matrix 131, and sums the two rows to thereby obtain the row #5 of the output matrix 145. Since only the row #14 of the intermediate matrix 144 corresponds to the row #6 of the sparse matrix 131, this row is taken as the row #6 of the output matrix 145. Then, the matrix multiplication unit 126 specifies the rows #15 to #16 of the intermediate matrix 144 corresponding to the row #7 of the sparse matrix 131, and sums the two rows to thereby obtain the row #7 of the output matrix 145.

In this connection, it is possible to easily parallelize the generation of the intermediate matrix 143 using a plurality of threads. For example, it is possible to perform the generation of different rows of the intermediate matrix 143 in parallel by assigning different threads to different non-zero elements of the non-zero element table 141. In addition, it is also possible to generate each element of the intermediate matrix 143 using one thread by assigning as many threads as the number of columns in the dense matrix 132 to each of the non-zero elements.

Further, it is possible to easily parallelize the generation of the intermediate matrix 144 using a plurality of threads. For example, it is possible to perform multiplications for different rows of the intermediate matrix 144 in parallel by assigning different threads to different non-zero elements indicated in the non-zero element table 141. It is also possible to compute each element of the intermediate matrix 144 using one thread by assigning as many threads as the number of columns in the dense matrix 132 to each non-zero element.

By the way, there are some parallelization methods considered for aggregating the intermediate matrix 144 to produce the output matrix 145. A first method is to assign one thread to each element of the intermediate matrix 144. Each thread is to perform an addition for one element of the output matrix 145. In this connection, this first method causes an overhead for exclusive control because a plurality of threads may access the same element in the output matrix 145.

A second method is to assign one thread to each element of the output matrix 145. This method does not need exclusive control because each thread exclusively performs computation for an element of the output matrix 145. However, with respect to a row with many non-zero elements in the sparse matrix 131, the second method may deteriorate the computation efficiency due to lack of parallelization. Consider the case where a certain row of the sparse matrix 131 has as many non-zero elements as A (A is an integer of four or more) and the corresponding A rows of the intermediate matrix 144 are summed. Theoretically, the sum of the A rows is achieved in log₂A steps using A/2 threads by hierarchically repeating a sum of two rows according to the binary tree approach. However, the second method needs to execute A-1 steps due to lack of the number of threads.

A third method is to assign a different number of threads for each element of the output matrix 145. For example, threads the number of which is determined according to the number of rows to be summed in the intermediate matrix 144, such as A/2 threads, are assigned for each element of the output matrix 145. Since different rows contain different numbers of non-zero elements in the sparse matrix 131, the third method needs to confirm the number of non-zero elements by scanning the row management table 142 in order from the first record and then determine mapping between a range of rows in the intermediate matrix 144 and threads to be assigned. Therefore, this thread assignment is complicated, and the thread assignment process itself is a large overhead.

In the following, it is assumed that the aggregation process is performed with the third method.

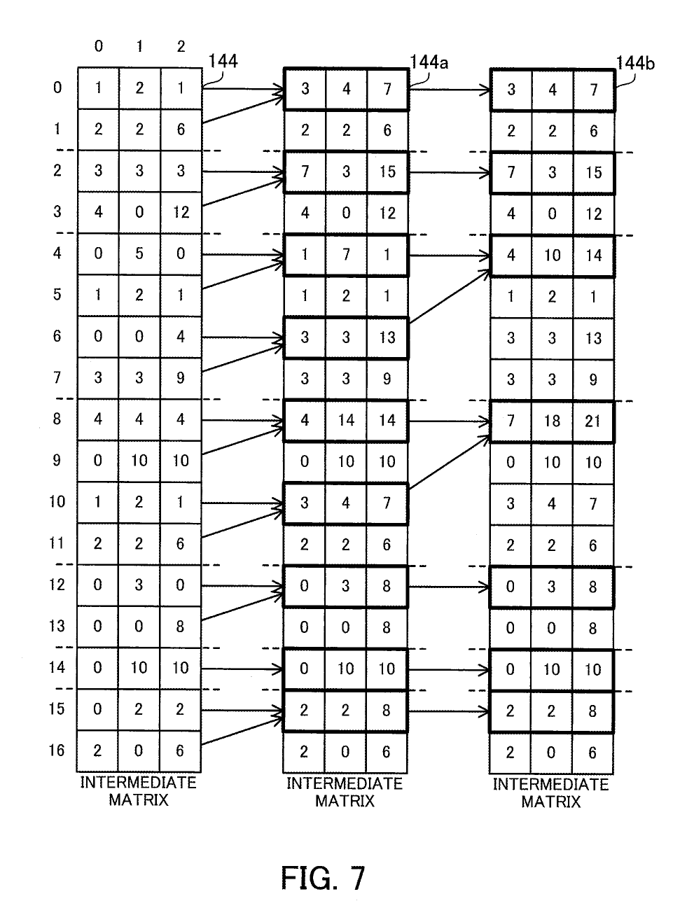

FIG. 7 illustrates an example of the aggregation process in the first matrix multiplication.

The matrix multiplication unit 126 sequentially overwrites appropriate elements in the intermediate matrix 144 during the aggregation process. The matrix multiplication unit 126 updates the intermediate matrix 144 to the intermediate matrix 144a and further updates the intermediate matrix 144a to the intermediate matrix 144b. The storage space storing the intermediate matrix 144 is usable as it is for the intermediate matrices 144a and 144b.

The matrix multiplication unit 126 refers to the row management table 142 to specify rows of the intermediate matrix 144 generated from each row of the sparse matrix 131. For example, the rows #0 and #1 of the intermediate matrix 144 correspond to the row #0 of the sparse matrix 131. The rows #2 and #3 of the intermediate matrix 144 correspond to the row #1 of the sparse matrix 131. The intermediate matrix 144 does not have any rows corresponding to the row #2 of the sparse matrix 131. The rows #4 to #7 of the intermediate matrix 144 correspond to the row #3 of the sparse matrix 131. The rows #8 to #11 of the intermediate matrix 144 correspond to the row #4 of the sparse matrix 131. The rows #12 and #13 of the intermediate matrix 144 correspond to the row #5 of the sparse matrix 131. The row #14 of the intermediate matrix 144 corresponds to the row #6 of the sparse matrix 131. The rows #15 and #16 of the intermediate matrix 144 correspond to the row #7 of the sparse matrix 131.

The matrix multiplication unit 126 hierarchically repeats a process of summing two rows within each range of rows divided as above, according to the binary tree approach. The sum of two rows is performed by adding the value of one row with higher row index to the value of the other row with lower row index, for each column. First, adjacent rows are summed, and then as the aggregation process progresses step by step, rows that are more separated from each other are summed. In the I-th step (I is an integer of zero or greater) in the aggregation process, rows separated from each other by 2^{I} are summed. The number of steps executed until the end of the aggregation process is log₂M, where M denotes the maximum value for the number of non-zero elements per row.

For example, in the 0th step for updating the intermediate matrix 144 to the intermediate matrix 144a, the values in the row #1 are added to the row #0 in the intermediate matrix 144. The values in the row #3 are added to the row #2. The values in the row #5 are added to the row #4, and the values in the row #7 are added to the row #6. The values in the row #9 are added to the row #8, and the values in the row #11 are added to the row #10. The values in the row #13 are added to the row #12. The row #14 remains as it is because there is no row that is to be added thereto. The values in the row #16 are added to the row #15.

Next, in the 1st step for updating the intermediate matrix 144a to the intermediate matrix 144b, the row #0 of the intermediate matrix 144a remains as it is because there is no row that is to be added thereto. The row #2 remains as it is because there is no row that is to be added thereto. The values in the row #6 are added to the row #4. The values in the row #10 are added to the row #8. The row #12 remains as it is because there is no row that is to be added thereto. The row #14 remains as it is because there is no row that is to be added thereto. The row #15 remains as it is because there is no row that is to be added thereto. The rows other than the above rows in the intermediate matrix 144a are ignored because the sum is already performed on these rows in the 0th step.

In this example, the maximum value for the number of non-zero elements per row is four. Therefore, the aggregation process is completed through the 0th and 1st steps. Rows corresponding to each row of the sparse matrix 131 are summed into one row at most in the intermediate matrix 144b. The rows of the intermediate matrix 144b as a result of the aggregation process correspond to the pair numbers indicated in the row management table 142. That is, the row #0 of the intermediate matrix 144b corresponds to the row #0 of the sparse matrix 131. The row #2 of the intermediate matrix 144b corresponds to the row #1 of the sparse matrix 131. There is no row in the intermediate matrix 144b corresponding to the row #2 of the sparse matrix 131. This means that a row vector with all zero elements corresponds to the row #2 of the sparse matrix 131. The row #4 of the intermediate matrix 144b corresponds to the row #3 of the sparse matrix 131. The row #8 of the intermediate matrix 144b corresponds to the row #4 of the sparse matrix 131. The row #12 of the intermediate matrix 144b corresponds to the row #5 of the sparse matrix 131. The row #14 of the intermediate matrix 144b corresponds to the row #6 of the sparse matrix 131. The row #15 of the intermediate matrix 144b corresponds to the row #7 of the sparse matrix 131. The rows other than the above rows in the intermediate matrix 144b are ignored because the sum is already performed on these rows in the 0th step and 1st step.

The matrix multiplication unit 126 extracts appropriate rows from the intermediate matrix 144b and produces the output matrix 145. The appropriate rows of the intermediate matrix 144b may be copied to produce the output matrix 145. Alternatively, without copying the rows, a view for viewing only the appropriate rows of the intermediate matrix 144b may be generated.

For example, the row #0 of the output matrix 145 is the row #0 of the intermediate matrix 144b. The row #1 of the output matrix 145 is the row #2 of the intermediate matrix 144b. The row #2 of the output matrix 145 is a row vector with all zero elements. The row #3 of the output matrix 145 is the row #4 of the intermediate matrix 144b. The row #4 of the output matrix 145 is the row #8 of the intermediate matrix 144b. The row #5 of the output matrix 145 is the row #12 of the intermediate matrix 144b. The row #6 of the output matrix 145 is the row #14 of the intermediate matrix 144b. The row #7 of the output matrix 145 is the row #15 of the intermediate matrix 144b.

The matrix multiplication unit 126 assigns one thread to each addition of two values. In the above 0th step, 24 (=8 rows×3 columns) additions are performed to update the intermediate matrix 144 to the intermediate matrix 144a, and 24 threads are therefore executed in parallel. In addition, in the above-described 1st step, six additions (=2 rows×3 columns) are performed to update the intermediate matrix 144a to the intermediate matrix 144b, and six threads are therefore executed in parallel. In this case, as the aggregation process proceeds step by step, the number of additions decreases. Therefore, a subset of threads used in a certain step is usable in the next step. In the above-described 1st step, a thread for calculating the row #4 of the intermediate matrix 144a may be used for calculating the row #4 of the intermediate matrix 144b, and a thread for calculating the row #8 of the intermediate matrix 144a may be used for calculating the row #8 of the intermediate matrix 144b. Therefore, it is possible to determine the thread assignment when the aggregation process starts.

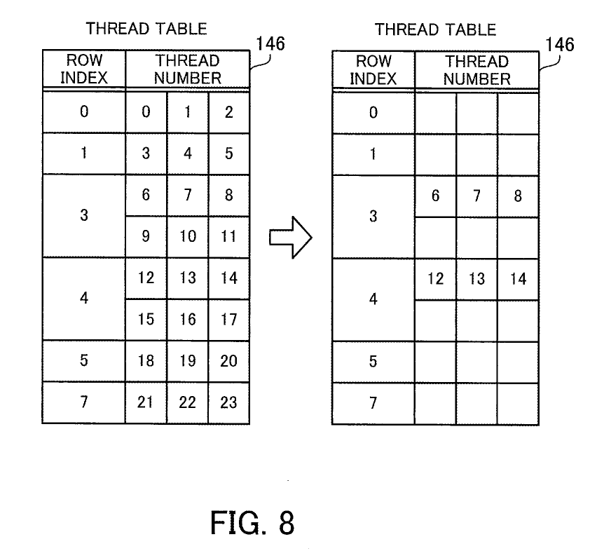

FIG. 8 illustrates an example of thread assignment in a first aggregation process.

The thread table 146 indicates thread assignment determined on the basis of the intermediate matrix 144. The thread table 146 is stored in the data storage unit 129.

The thread table 146 has the following fields: Row Index and Thread Number. The Row Index field indicates the row index of a row that has one or more non-zero elements in the sparse matrix 131. The Thread Number field has a two-dimensional array that contains thread numbers identifying threads assigned to the corresponding row of the sparse matrix 131. The number of rows in this two-dimensional array is A/2 (rounded down to the nearest integer), where A denotes the number of non-zero elements. The number of columns in the two-dimensional array equals the number of columns in the dense matrix 132.

As described above, in the 0th step of the aggregation process for the intermediate matrix 144, 24 additions are performed, and 24 threads are therefore assigned. More specifically, threads #0 to #2 are assigned to the row #0, threads #3 to #5 are assigned to the row #1, threads #6 to #11 are assigned to the row #3, threads #12 to #17 are assigned to the row #4, threads #18 to #20 are assigned to the row #5, and threads #21 to #23 are assigned to the row #7.

For example, the thread #0 is to add the value at [1,0] to [0,0] in the intermediate matrix 144. The thread #1 is to add the value at [1,1] to [0,1]. The thread #2 is to add the value at [1,2] to [0,2]. In addition, the thread #6 is to add the value at [5,0] to [4,0]. The thread #7 is to add the value at [5,1] to [4,1]. The thread #8 is to add the value at [5,2] to [4,2]. The thread #9 is to add the value at [7,0] to [6,0]. The thread #10 is to add the value at [7,1] to [6,1]. The thread #11 is to add the value at [7,2] to [6,2].

In the 0th step of the aggregation process, all these threads are executed in parallel. In the subsequent steps, some of these threads are executed in parallel. As described above, six additions are performed on the intermediate matrix 144 in the 1st step of the aggregation process, so that six out of the threads #0 to #23 are executed in parallel. More specifically, the threads #6 to #8 and #12 to #14 are executed and the other threads are not executed.

For example, the thread #6 is to add the value at [6,0] to [4,0] in the intermediate matrix 144a. The thread #7 is to add the value at [6,1] to [4,1]. The thread #8 is to add the value at [6,2] to [4,2]. The thread #12 is to add the value at [10,0] to [8,0]. The thread #13 is to add the value at [10,1] to [8,1]. The thread #14 is to add the value at [10,2] to [8,2]. Then, the aggregation process is completed.

The following describes a process regarding the first CSR data.

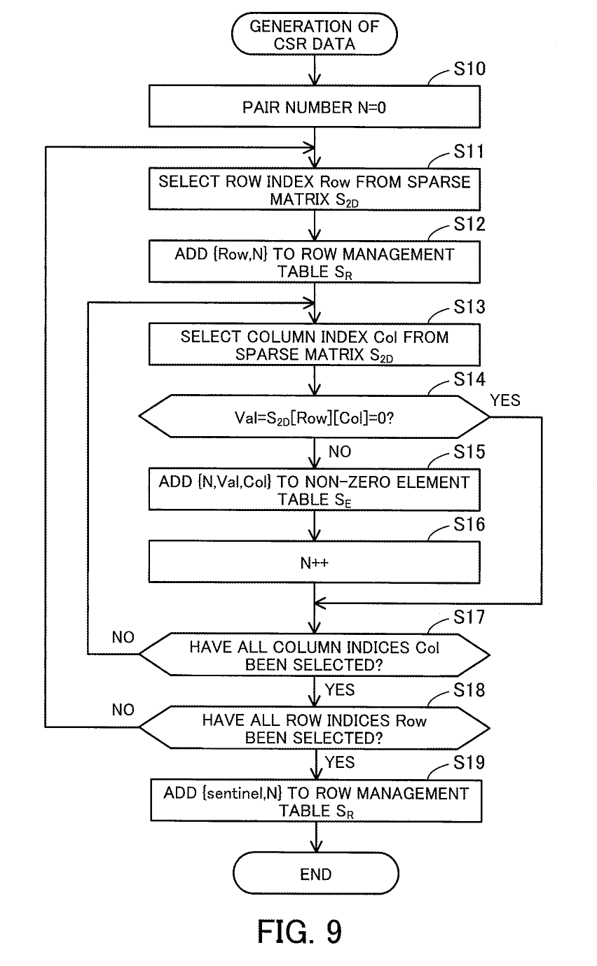

FIG. 9 is a flowchart illustrating how to generate the first CSR data.

The first CSR data is generated after the sparse matrix generation unit 123 generates the sparse matrix 131 in the form of two-dimensional structure data in accordance with inputs from the user application 121.

(S10) The data structure conversion unit 124 initializes the pair number N to zero (i.e., N=0).

(S11) The data structure conversion unit 124 selects one of the row indices in the sparse matrix 131 (sparse matrix S_{2D}) in increasing order (row index Row).

(S12) The data structure conversion unit 124 adds a record {Row, N} including the row index Row and the pair number N at the end of the row management table 142 (row management table S_{R}).

(S13) The data structure conversion unit 124 selects one of the column indices in the sparse matrix 131 in increasing order (column index Col) with respect to the selected row index Row.

(S14) The data structure conversion unit 124 extracts a value S_{2D}[Row][Col] (i.e., value Val) from the Row-th row and Col-th column of the sparse matrix 131, and determines whether Val=0 is satisfied. If Val=0 is satisfied, i.e., if S_{2D}[Row] [Col] is a zero element, the process proceeds to step S17. If Val=0 is not satisfied, i.e., if S_{2D}[Row] [Col] is a non-zero element, the process proceeds to step S15.

(S15) The data structure conversion unit 124 adds a record {N, Val, Col} including the pair number N, the value Val, and the column index Col at the end of the non-zero element table 141 (non-zero element table S_{E}).

(S16) The data structure conversion unit 124 increments the pair number N by one.

(S17) The data structure conversion unit 124 determines whether all column indices Col have been selected with respect to the row index Row at step S13. If all the column indices Col have been selected, the process proceeds to step S18. If any column index Col has not been selected, the process proceeds to step S13.

(S18) The data structure conversion unit 124 determines whether all row indices Row have been selected at step S11. If all the row indices Row have been selected, the process proceeds to step S19. If any row index Row has not been selected, the process proceeds to step S11.

(S19) The data structure conversion unit 124 adds a record {sentinel, N} including “sentinel” and the pair number N at the end of the row management table 142.

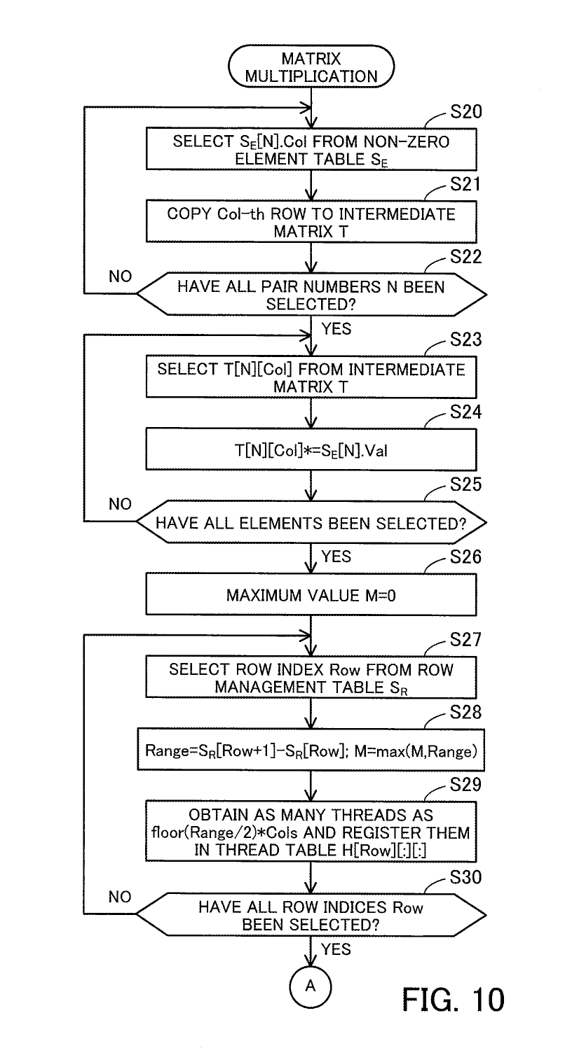

FIG. 10 is a flowchart illustrating an example of how to perform the first matrix multiplication.

The first matrix multiplication is performed after the data structure conversion unit 124 generates the first CSR data and the dense matrix generation unit 125 generates the dense matrix 132 in the form of two-dimensional structure data.

(S20) The matrix multiplication unit 126 selects one of the pair numbers in the non-zero element table 141 (pair number N), and obtains a column index S_{E}[N].Col corresponding to the pair number N.

(S21) The matrix multiplication unit 126 copies the Col-th row of the dense matrix 132 (dense matrix D) to the N-th row of the intermediate matrix 143 (intermediate matrix T).

(S22) The matrix multiplication unit 126 determines whether all pair numbers N in the non-zero element table 141 have been selected at step S20. If all the pair numbers N have been selected, the process proceeds to step S23. If any pair number N has not been selected, the process proceeds to step S20. In this connection, the steps S20 and S21 may be parallelized using a plurality of threads.

(S23) The matrix multiplication unit 126 selects one of the row indices and one of the column indices (row index N and column index Col) in the intermediate matrix 143 and extracts an element T[N] [Col] from the N-th row and Col-th column of the intermediate matrix 143.

(S24) The matrix multiplication unit 126 extracts a value S_{E}[N].Val corresponding to the pair number N from the non-zero element table 141. The matrix multiplication unit 126 multiplies the element T[N] [Col] extracted at step S23 by the value S_{E}[N].Val.

(S25) The matrix multiplication unit 126 determines whether all elements in the intermediate matrix 143 have been selected at step S23. If all the elements have been selected, the process proceeds to step S26. If any element has not been selected, the process proceeds to step S23. In this connection, these steps S23 and S24 may be parallelized using a plurality of threads.

(S26) The matrix multiplication unit 126 initializes the maximum value M to zero (i.e., M=0).

(S27) The matrix multiplication unit 126 selects one of the row indices in the row management table 142 in increasing order (row index Row).

(S28) The matrix multiplication unit 126 searches the row management table 142 to find a pair number S_{R}[Row] corresponding to the row index Row and a pair number S_{R}[Row+1] corresponding to the row index Row+1. The matrix multiplication unit 126 calculates the number of pairs Range=S_{R}[Row+1]−S_{R}[Row]. In addition, the matrix multiplication unit 126 takes the current maximum value M or the number of pairs Range, whichever is greater, as the maximum M (M=max(M, Range).

(S29) The matrix multiplication unit 126 obtains as many threads as floor(Range/2)×Cols from the thread pool 128. The “floor” represents a floor function, which rounds a positive number down to the nearest integer. The “Cols” represents the number of columns in the intermediate matrix 144 (intermediate matrix T) obtained by updating the intermediate matrix 143. The matrix multiplication unit 126 fills in a two-dimensional array H[Row][:][:] corresponding to the row index Row of the thread table 146 (thread table H) with the thread numbers of the obtained threads. The number of rows in the two-dimensional array H[Row][:][:] is floor(Range/2), and the number of columns therein is Cols.

(S30) The matrix multiplication unit 126 determines whether all row indices Row in the row management table 142 have been selected at step S27. If all the row indices Row have been selected, the process proceeds to step S31. If any row index Row has not been selected, the process proceeds to step S27.

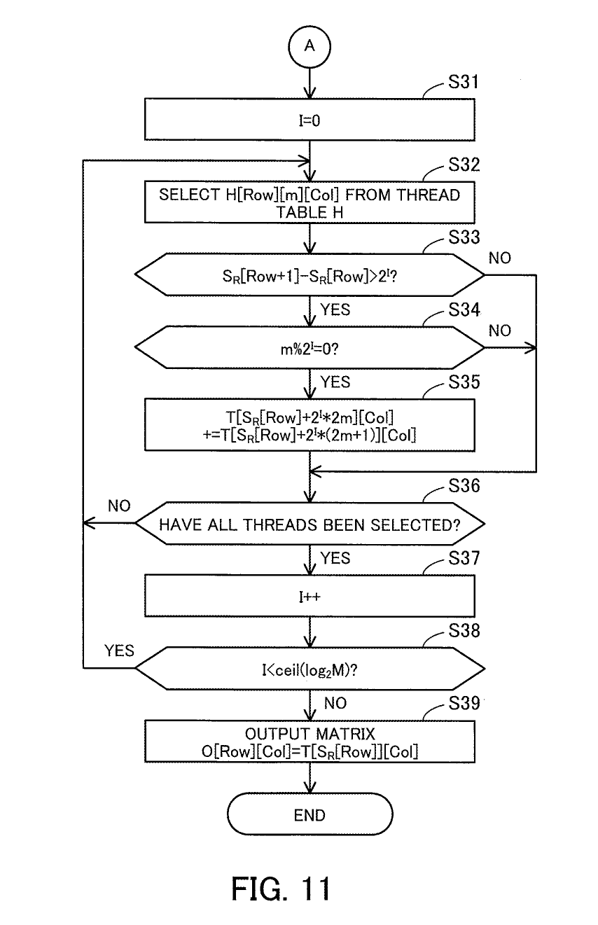

FIG. 11 is a continuation flowchart of the flowchart started in FIG. 10.

(S31) The matrix multiplication unit 126 initializes an iteration count I to zero (i.e., I=0).

(S32) The matrix multiplication unit 126 selects one (H[Row][m][Col]) of the thread numbers in the thread table 146. The location of a thread number is specified by a row index Row, a row index m in the two-dimensional array, and a column index Col in the two-dimensional array. Steps S33 to S35 are executed using a thread indicated by the selected thread number.

(S33) The matrix multiplication unit 126 searches the row management table 142 to find a pair number S_{R}[Row] corresponding to the row index Row and a pair number S_{R}[Row+1] corresponding to the row index Row+1. The matrix multiplication unit 126 determines whether S_{R}[Row+1]−S_{R}[Row]>2^{I} is satisfied, i.e., whether the number of pairs corresponding to the row index Row exceeds 2^{I}. If this condition is satisfied, the process proceeds to step S34. If the condition is not satisfied, the process proceeds to step S36.

(S34) The matrix multiplication unit 126 determines whether a remainder obtained by dividing the row index m by 2^{I} is zero, i.e., whether m % 2^{I}=0. If this condition is satisfied, the process proceeds to step S35. If the condition is not satisfied, the process proceeds to step S36.

(S35) The matrix multiplication unit 126 extracts the element T[S_{R}[Row]+2^{I}×2m][Col] and the element T[S_{R}[Row]+2^{I}×(2m+1)][Col] from the intermediate matrix 144, and adds the value of the latter to the former to update the intermediate matrix 144.

(S36) The matrix multiplication unit 126 determines whether all thread numbers have been selected from the thread table 146 at step S32. If all the thread numbers have been selected, the process proceeds to step S37. If any thread number has not been selected, the process proceeds to step S32. In this connection, steps S33 to S35 may be parallelized.

(S37) The matrix multiplication unit 126 increments the iteration count I by one.

(S38) The matrix multiplication unit 126 determines whether I<ceil(log₂M) is satisfied. The “ceil” is a ceiling function, which rounds a positive value up to the nearest integer. The “M” denotes the maximum value for the number of non-zero elements calculated at step S28. If this condition is satisfied, the process proceeds to step S32. If the condition is not satisfied, the process proceed to step S39.

(S39) The matrix multiplication unit 126 selects a row index and a column index (row index Row and column index Col) from the output matrix 145 (output matrix O). The matrix multiplication unit 126 searches the row management table 142 to find a pair number S_{R}[Row] corresponding to the row index Row and then extracts the element T[S_{R}[Row]][Col] from the intermediate matrix 144. The matrix multiplication unit 126 takes the value of T[S_{R}[Row]][Col] as the value of 0[Row][Col]. The matrix multiplication unit 126 repeats this operation with respect to each row and each column to thereby produce the output matrix 145.

The first matrix multiplication has been described. The first matrix multiplication needs complicated parallelization of the aggregation process for the intermediate matrix 144, and may thus underutilize the operational capability of the GPGPU 102, which is able to execute a large number of threads in parallel. On the other hand, the matrix computation library 122 is able to perform the second matrix multiplication employing a format that is an extension of the compressed row storage format. The following describes the second matrix multiplication.

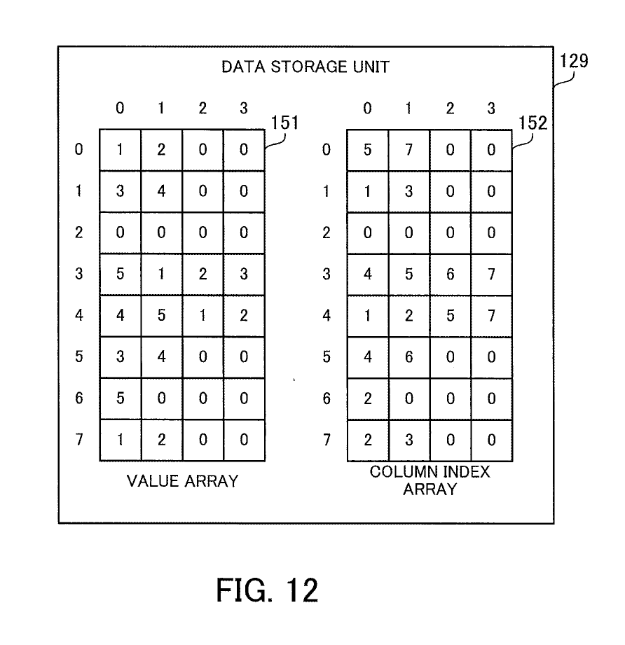

FIG. 12 illustrates an example of the second CSR data.

In the second matrix multiplication, a value array 151 (value array S_{V}) and a column index array 152 (column index array S_{C}) are generated from the sparse matrix 131, instead of the first CSR data. The value array 151 and column index array 152 are stored in the data storage unit 129.

The value array 151 is a two-dimensional array containing the values of the non-zero elements in the sparse matrix 131. The column index array 152 is a two-dimensional array containing the column indices of columns to which the non-zero elements of the sparse matrix 131 belong. The number of rows and the number of columns in the value array 151 equal those in the column index array 152, respectively. Elements at corresponding locations in the value array 151 and the column index array 152 have correspondence relationship. The number of rows in the value array 151 and column index array 152 equals the number of rows in the sparse matrix 131, and the number of columns therein is equal to the maximum value (the above-described maximum value M) for the number of non-zero elements in each row of the sparse matrix 131.

In the value array 151, the values of the non-zero elements in each row of the sparse matrix 131 are left-aligned. Then, dummy elements with a value of zero are added for each row that has fewer non-zero elements than the maximum value so as to equalize the number of elements among the rows in the value array 151. In the case of the sparse matrix 131 of FIG. 4, the maximum value for the number of non-zero elements is four, and therefore the value array 151 is a two-dimensional array with eight rows and four columns.

The number of non-zero elements in the row #0 of the sparse matrix 131 is two. Therefore, the values of the non-zero elements are registered in the columns #0 and #1 of the value array 151, and a value of zero is registered in the columns #2 and #3. The number of non-zero elements in the row #1 is two. Therefore, the values of the non-zero elements are registered in the columns #0 and #1, and a value of zero is registered in the columns #2 and #3. The number of non-zero elements in the row #2 is zero. Therefore, a value of zero is registered in the columns #0 to #3. The number of non-zero elements in the row #3 is four. Therefore, the values of the non-zero elements are registered in the columns #0 to #3. The number of non-zero elements in the row #4 is four. Therefore, the values of the non-zero elements are registered in the columns #0 to #3. The number of non-zero elements in the row #5 is two. Therefore, the values of the non-zero elements are registered in the columns #0 and #1, and a value of zero is registered in the columns #2 and #3. The number of non-zero elements in the row #6 is one. Therefore, the value of the non-zero element is registered in the column #0, and a value of zero is registered in the columns #1 to #3. The number of non-zero elements in the row #7 is two. Therefore, the values of the non-zero elements are registered in the columns #0 and #1, and a value of zero is registered in the columns #2 and #3.

In the column index array 152, the column indices of columns to which non-zero elements belong are registered at locations corresponding to where the values of the non-zero elements are registered in the value array 151. On the other hand, dummy elements are registered at locations corresponding to where zero is registered in the value array 151, as in the value array 151. By doing so, the number of elements is equalized among the rows in the column index array 152. The dummy elements in the column index array 152 have a prescribed column index, such as zero. Alternatively, a desired column index is usable as the column indices of dummy elements as long as the column index actually exists in the sparse matrix 131. In the following description, a column index of zero is used as the column indices of the dummy elements. In the case of the sparse matrix 131 of FIG. 4, the column index array 152 is a two-dimensional array with eight rows and four columns, as in the value array 151.

Note that, in the second embodiment, a two-dimensional array is used as the value array 151. Alternatively, a one-dimensional array is usable, where non-zero elements and dummy elements are arranged in increasing order of row indices. Similarly, a one-dimensional array is usable as the column index array 152. In addition, in the second embodiment, the value array 151 and the column index array 152 are separate arrays. Alternatively, these arrays may be incorporated in a single table.

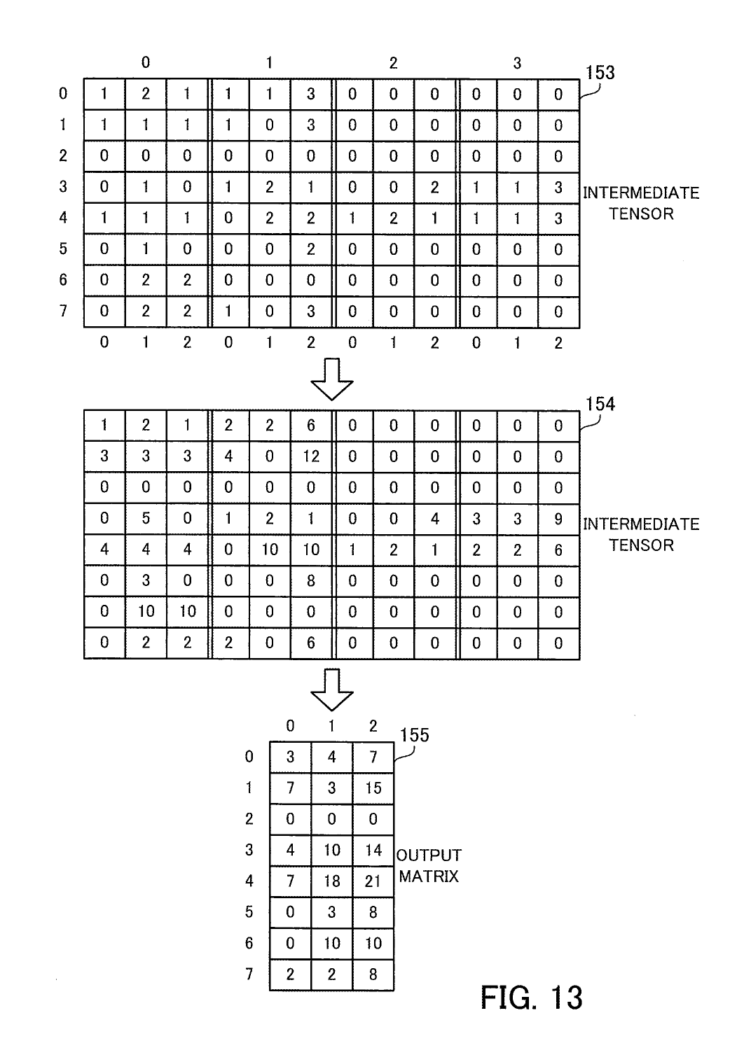

FIG. 13 illustrates an example of matrix multiplication using the second CSR data.

In the case where the sparse matrix 131 is represented by using the value array 151 and column index array 152, the matrix multiplication unit 126 is able to perform matrix multiplication as follows. As in the first matrix multiplication using the first CSR data, the computation of the matrix multiplication in this case is divided into a copy process as a first process, a multiplication process as a second process, and an aggregation process as a third process.

In the copy process, the matrix multiplication unit 126 generates an intermediate tensor 153 from the column index array 152. The intermediate tensor 153 is a three-dimensional array in which each element is specified by a first three-dimensional coordinate (X coordinate), a second three-dimensional coordinate (Y coordinate), and a third three-dimensional coordinate (Z coordinate). The intermediate tensor 153 is stored in the data storage unit 129. The number of X coordinates equals the number of rows in the column index array 152, i.e., the number of rows in the sparse matrix 131. The number of Y coordinates equals the number of columns in the column index array 152, i.e., the maximum value for the number of non-zero elements. The number of Z coordinates equals the number of columns in the dense matrix 132.

The matrix multiplication unit 126 extracts a column index from the column index array 152, extracts a row whose row index is equal to the extracted column index from the dense matrix 132, and stores the extracted row in the intermediate tensor 153. In this case, the rows and columns of the column index array 152 correspond to the X and Y coordinates in the intermediate tensor 153, respectively. In addition, the column indices of the dummies included in the column index array 152 are processed in the same way as the other column indices.

For example, the intermediate tensor 153 includes 32 (=8×4) pairs of X and Y coordinates. With respect to 17 out of these 32 pairs, copies of the corresponding rows in the dense matrix 132 are stored according to the column indices of elements that are not dummies in the column index array 152. With respect to the remaining 15 pairs, a copy of a specified row in the dense matrix 132 is stored according to the column index of the dummy elements in the column index array 152. In the second embodiment, since dummy elements have a column index of zero, the row #0 in the dense matrix 132 is stored at locations that do not contain non-zero elements.

In the multiplication process, the matrix multiplication unit 126 generates an intermediate tensor 154 from the intermediate tensor 153. The intermediate tensor 154 is an update of the intermediate tensor 153. If the intermediate tensor 154 is generated by overwriting the intermediate tensor 153, a different storage space does not need to be used.

The matrix multiplication unit 126 extracts a value from the value array 151 and multiplies its corresponding elements in the intermediate tensor 153 by the extracted value. The dummy elements in the value array 151 are processed in the same way as the non-zero elements. For example, the matrix multiplication unit 126 multiplies each element at X=0, Y=0, Z=0 to 2 in the intermediate tensor 153 by the element value “1” at the 0th row and 0th column in the value array 151 (the value of each element is increased by one-fold). In addition, the matrix multiplication unit 126 multiplies each element at X=0, Y=1, Z=0 to 2 in the intermediate tensor 153 by the element value “2” at the 0th row and 1st column in the value array 151 (the value of each element is increased by two-fold). That is, with respect to 17 out of the 32 pairs of X and Y coordinates registered in the intermediate tensor 153, the elements of each pair are multiplied by the value of the corresponding non-zero element. On the other hand, with respect to the remaining 15 pairs, the elements of each pair are multiplied by zero, which is the value of a dummy element.

In the aggregation process, the matrix multiplication unit 126 adds up the values of corresponding elements in the intermediate tensor 154 for each pair of X and Z coordinates, to thereby produce an output matrix 155. This means that the same number of row vectors are summed for each X coordinate in the intermediate tensor 154. The output matrix 155 is identical to the output matrix 155 produced in the first matrix multiplication, and is stored in the data storage unit 129. The output matrix 155 is a two-dimensional matrix in which the number of rows equals the number of rows in the sparse matrix 131 and the number of columns equals the number of columns in the dense matrix 132. The rows and columns in the output matrix 155 correspond to the X and Z coordinates in the intermediate tensor 154, respectively. The elements in the intermediate tensor 154 generated from the dummy elements of the value array 151 are processed in the same way as the other elements.

For example, four row vectors with X=0 and Y=0 to 3 in the intermediate tensor 154 are summed to thereby obtain the row #0 of the output matrix 155. Four row vectors with X=1 and Y=0 to 3 in the intermediate tensor 154 are summed to thereby obtain the row #1 of the output matrix 155. Four row vectors with X=2 and Y=0 to 3 in the intermediate tensor 154 are summed to thereby obtain the row #2 of the output matrix 155. Four row vectors with X=3 and Y=0 to 3 in the intermediate tensor 154 are summed to thereby obtain the row #3 of the output matrix 155.

In addition, four row vectors with X=4 and Y=0 to 3 in the intermediate tensor 154 are summed to thereby obtain the row #4 of the output matrix 155. Four row vectors with X=5 and Y=0 to 3 in the intermediate tensor 154 are summed to thereby obtain the row #5 of the output matrix 155. Four row vectors with X=6, Y=0 to 3 in the intermediate tensor 154 are summed to thereby obtain the row #6 of the output matrix 155. Four row vectors with X=7 and Y=0 to 3 in the intermediate tensor 154 are summed to thereby obtain the row #7 of the output matrix 155. As described above, unlike the first matrix multiplication, the same number of row vectors in the intermediate tensor 154 are summed for each row of the output matrix 155 in the second matrix multiplication.

In this connection, it is possible to easily parallelize the generation of the intermediate tensor 153 using a plurality of threads. For example, different threads are assigned to different elements in the column index array 152. By doing so, it becomes possible to perform the copy process on different pairs of X and Y coordinates in the intermediate tensor 153 in parallel. In addition, it is also possible to easily parallelize the generation of the intermediate tensor 154 using a plurality of threads. For example, different threads are assigned to different elements in the value array 151. By doing so, it becomes possible to perform the multiplication process on different pairs of X and Y coordinates in the intermediate tensor 154 in parallel. Furthermore, it is possible to parallelize the generation of the output matrix 155 using a plurality of threads.

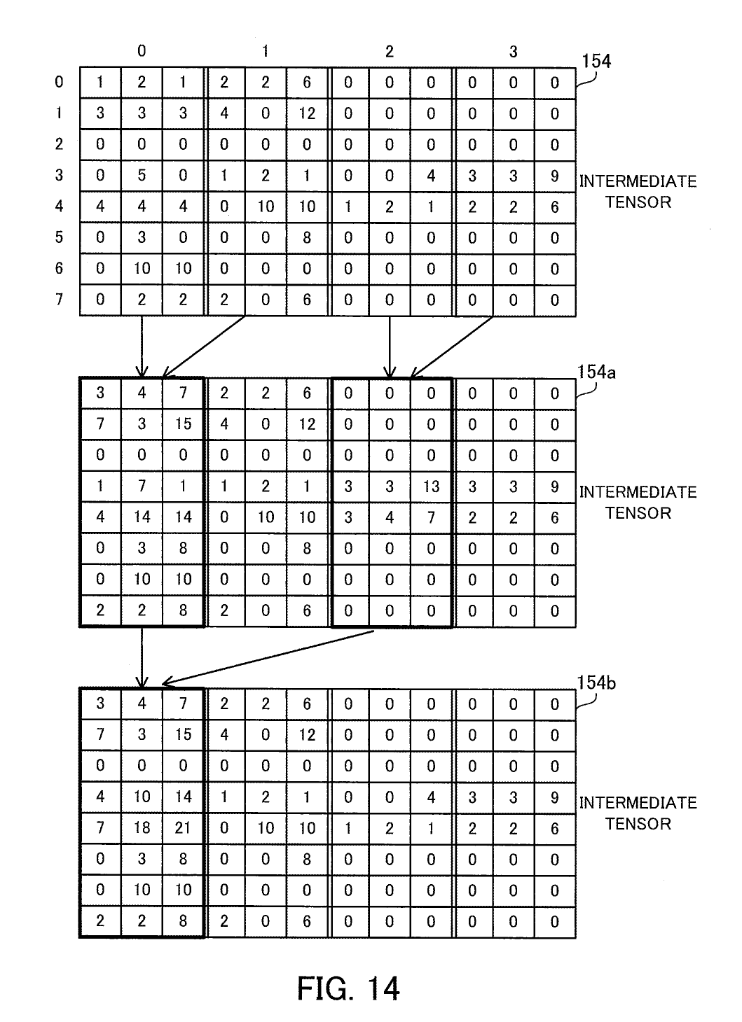

FIG. 14 illustrates the aggregation process in the second matrix multiplication.

The matrix multiplication unit 126 sequentially overwrites appropriate elements in the intermediate tensor 154 during the aggregation process. The matrix multiplication unit 126 updates the intermediate tensor 154 to the intermediate tensor 154a and further updates the intermediate tensor 154a to the intermediate tensor 154b. A different storage space is not needed for the intermediate tensors 154a and 154b.

The matrix multiplication unit 126 hierarchically repeats a sum of two row vectors with different Y coordinates within each X coordinate of the intermediate tensor 154 according to the binary tree approach. The two row vectors are summed by adding the value of an element with higher Y coordinate to the value of the other element with lower Y coordinate at each Z coordinate. First, row vectors whose Y coordinates are separated by one are summed, and as the aggregation process progresses, row vectors whose Y coordinates are more separated from each other are summed. In the I-th step (I is an integer of zero or greater) in the aggregation process, row vectors whose Y coordinates are separated by 2^{I} are summed. The number of steps executed until the end of the aggregation process is log₂M, where M denotes the number of Y coordinates in the intermediate tensor 154.

For example, in the 0th step for updating the intermediate tensor 154 to the intermediate tensor 154a, with respect to each X coordinate, the value at Y=1, Z=0 is added to the value at Y=0, Z=0, the value at Y=1, Z=1 is added to the value at Y=0, Z=1, the value at Y=1, Z=2 is added to the value at Y=0, Z=2. In addition, with respect to each X coordinate, the value at Y=3, Z=0 is added to the value at Y=2, Z=0, the value at Y=3, Z=1 is added to the value at Y=2, Z=1, the value at Y=3, Z=2 is added to the value at Y=2, Z=2.

Next, in the 1st step for updating the intermediate tensor 154a to the intermediate tensor 154b, with respect to each X coordinate, the value at Y=2, Z=0 is added to the value at Y=0, Z=0, the value at Y=2, Z=1 is added to the value at Y=0, Z=1, and the value at Y=2, Z=2 is added to the value at Y=0, Z=2. The elements other than the above are ignored because the sum is already performed on these elements in the 0th step.

In this example, the intermediate tensor 154 has four Y coordinates. Therefore, the aggregation process is completed through the 0th and 1st steps. The aggregation process results in the row vectors with Y=0 in the intermediate tensor 154b. The matrix multiplication unit 126 extracts the row vectors with Y=0 from the intermediate tensor 154b to thereby produce the output matrix 155. A copy of the appropriate row vectors in the intermediate tensor 154b may be made to produce the output matrix 155. Alternatively, a view for viewing only the appropriate row vectors in the intermediate tensor 154b may be generated, without making the copy of the row vectors.

For example, the row #0 of the output matrix 155 is a row with X=0, Y=0 in the intermediate tensor 154b. The row #1 of the output matrix 155 is a row with X=1, Y=0 in the intermediate tensor 154b. The row #2 of the output matrix 155 is a row with X=2, Y=0 in the intermediate tensor 154b. The row #3 of the output matrix 155 is a row with X=3, Y=0 in the intermediate tensor 154b. The row #4 of the output matrix 155 is a row with X=4, Y=0 in the intermediate tensor 154b. The row #5 of the output matrix 155 is a row with X=5, Y=0 in the intermediate tensor 154b. The row #6 of the output matrix 155 is a row with X=6, Y=0 in the intermediate tensor 154b. The row #7 of the output matrix 155 is a row with X=7, Y=0 in the intermediate tensor 154b.

The matrix multiplication unit 126 assigns one thread to each addition of two values. In the above-described 0th step, 48 (=8×2×3) additions are performed, and 48 threads are therefore executed in parallel. In addition, in the above-described 1st step, 24 (=8×1×3) additions are performed, and 24 threads are therefore executed in parallel. In this connection, the number of additions decreases as the aggregation process progresses. Therefore, a subset of threads used in a certain step is usable in the next step. In the above-described 1st step, a thread used for a calculation for X=0, Y=0, Z=0 in the intermediate tensor 154a may be used for a calculation for X=0, Y=0, Z=0 in the intermediate tensor 154b. Therefore, thread assignment is determined when the aggregation process starts.

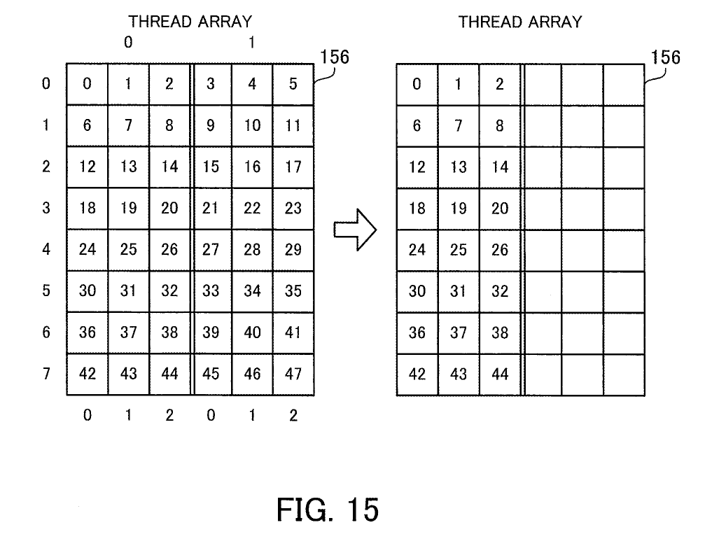

FIG. 15 illustrates an example of thread assignment in a second aggregation process.

A thread array 156 indicates thread assignment determined based on the intermediate tensor 154. The thread array 156 is stored in the data storage unit 129. The thread array 156 is a three-dimensional array, in which each element is specified by a first three-dimensional coordinate (X coordinate), a second three-dimensional coordinate (Y coordinate), and a third three-dimensional coordinate (Z coordinate). The number of X coordinates in the thread array 156 equals that in the intermediate tensor 154. The number of Y coordinates in the thread array 156 is equal to M/2 (rounded down to the nearest integer), where M denotes the number of Y coordinates in the intermediate tensor 154. The number of Z coordinates in the thread array 156 equals that in the intermediate tensor 154.

Thread numbers each identifying a thread are registered in the thread array 156. An equal number of threads are assigned to each X coordinate in the intermediate tensor 154. Since 48 additions are performed in the 0th step in the aggregation process performed on the intermediate tensor 154, as described above, 48 threads are assigned. For example, threads #0 to #5 are assigned to X=0, threads #6 to #11 are assigned to X=1, threads #12 to #17 are assigned to X=2, threads #18 to #23 are assigned to X=3. In addition, threads #24 to #29 are assigned to X=4, threads #30 to #35 are assigned to X=5, threads #36 to #41 are assigned to X=6, and threads #42 to #47 are assigned to X=7.

The thread #0 is to add the value at [X,Y,Z]=[0,1,0] to [0,0,0] in the intermediate tensor 154. The thread #1 is to add the value at [0,1,1] to [0,0,1]. The thread #2 is to add the value at [0,1,2] to [0,0,2]. The thread #3 is to add the value at [0,3,0] to [0,2,0]. The thread #4 is to add the value at [0,3,1] to [0,2,1]. The thread #5 is to add the value at [0,3,2] to [0,2,2].

In the 0th step in the aggregation process, all these threads are executed in parallel. In the subsequent steps, some of these threads are executed in parallel. As described above, 24 additions are performed in the 1st step in the aggregation process for the intermediate tensor 154, and therefore 24 out of the threads #0 to #47 are executed in parallel. For example, threads #0 to #2, #6 to #8, #12 to #14, #18 to #20, #24 to #26, #30 to #32, #36 to #38, and #42 to #44 are executed, and the other threads are not executed.

The thread #0 is to add the value at [X,Y,Z]=[0,2,0] to [0,0,0] in the intermediate tensor 154a. The thread #1 is to add the value at [0,2,1] to [0,0,1]. The thread #2 is to add the value at [0,2,2] to [0,0,2].

The first matrix multiplication uses 24 threads in the aggregation process, whereas the second matrix multiplication uses 48 threads, more than the first matrix multiplication. In addition, the second matrix multiplication involves extra operations using dummy elements, such as multiplications of zero and additions of zero. However, the second matrix multiplication makes it easy to map threads to ranges of data in the intermediate tensor 154, and thus it is easy to control the parallelization processing. Therefore, the use of the GPGPU 102, which is able to execute a large number of threads in parallel, achieves efficient parallelization processing and thus reduces the execution time.

The following describes processing regarding the second CSR data.

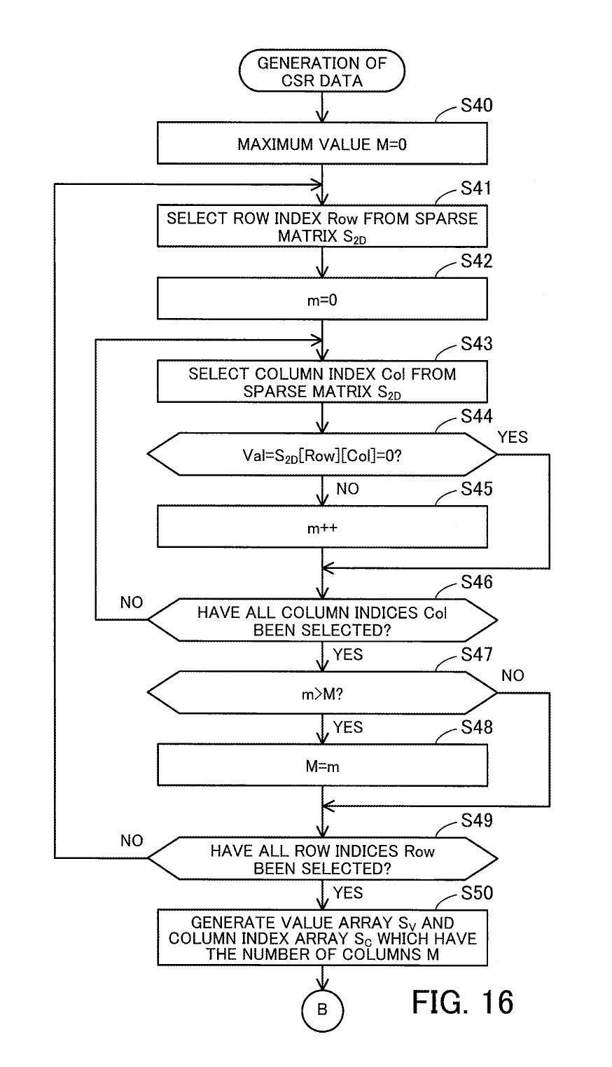

FIG. 16 is a flowchart illustrating an example of how to generate the second CSR data.

The second CSR data is generated after the sparse matrix generation unit 123 generates the sparse matrix 131 in the form of two-dimensional structure data according to inputs from the user application 121.

(S40) The data structure conversion unit 124 initializes the maximum value M to zero (i.e., M=0).

(S41) The data structure conversion unit 124 selects one (row index Row) of the row indices in the sparse matrix 131 (sparse matrix S_{2D}).

(S42) The data structure conversion unit 124 initializes the number of non-zero elements m to zero (i.e., m=0).

(S43) The data structure conversion unit 124 selects one (column index Col) of the column indices in the sparse matrix 131 with respect to the selected row index Row.

(S44) The data structure conversion unit 124 extracts a value S_{2D}[Row] [Col] (value Val) from the Row-th row and Col-th column of the sparse matrix 131, and determines whether Val=0 is satisfied. If Val=0 is satisfied, i.e., if S_{2D}[Row] [Col] is a zero element, the process proceeds to step S46. If Val=0 is not satisfied, i.e., if S_{2D}[Row] [Col] is a non-zero element, the process proceeds to step S45.

(S45) The data structure conversion unit 124 increments the number of non-zero elements m by one.

(S46) The data structure conversion unit 124 determines whether all column indices Col have been selected with respect to the row index Row at step S43. If all the column indices Col have been selected, the process proceeds to step S47. If any column index Col has not been selected, the process proceeds to step S43.

(S47) The data structure conversion unit 124 compares the number of non-zero elements m having the row index Row with the maximum value M, to determine whether m is greater than M. If m is greater than M, the process proceeds to step S48. If m is less than or equal to M, the process proceeds to step S49.

(S48) The data structure conversion unit 124 sets the maximum value M to the number of non-zero elements m.

(S49) The data structure conversion unit 124 determines whether all row indices Row have been selected at step S41. If all the row indices Row have been selected, the process proceeds to step S50. If any row index Row has not been selected, the process proceeds to step S41.

(S50) The data structure conversion unit 124 generates a value array 151 (value array Sᵥ) that has as many rows as the sparse matrix 131 and as many columns as the maximum value M. In addition, the data structure conversion unit 124 generates a column index array 152 (column index array S_{c}) that has as many rows as the sparse matrix 131 and as many columns as the maximum value M. The data structure conversion unit 124 initializes each element in the value array 151 and column index array 152 to zero.

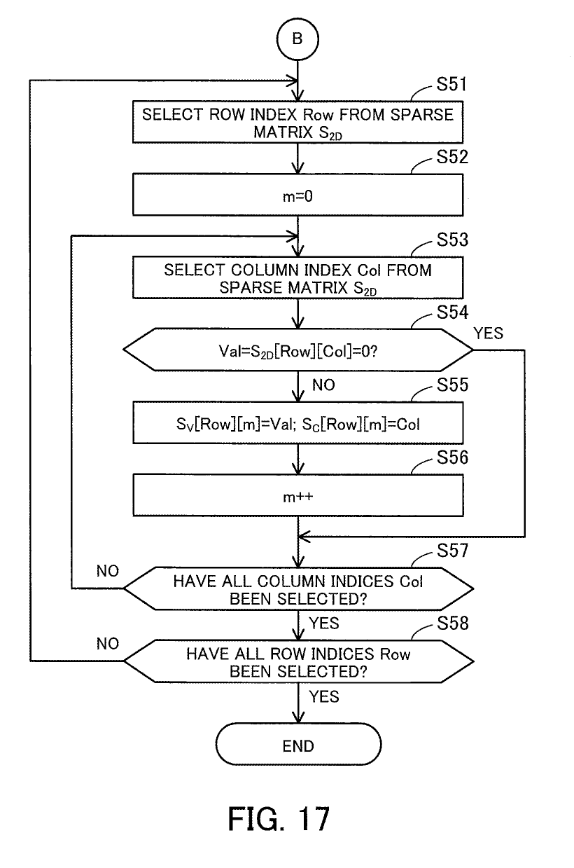

FIG. 17 is a continuation flowchart of the flowchart started in FIG. 16.

(S51) The data structure conversion unit 124 selects one (row index Row) of the row indices in the sparse matrix 131.

(S52) The data structure conversion unit 124 initializes the number of non-zero elements m to zero (i.e., m=0).

(S53) The data structure conversion unit 124 selects one (column index Col) of the column indices in the sparse matrix 131 with respect to the selected row index Row.

(S54) The data structure conversion unit 124 extracts a value S_{2D}[Row][Col] (value Val) from the Row-th row and Col-th column of the sparse matrix 131, and determines whether Val=0 is satisfied. If Val=0 is satisfied, i.e., if S_{2D}[Row][Col] is a zero element, the process proceeds to step S57. If Val=0 is not satisfied, i.e., if S_{2D}[Row][Col] is a non-zero element, the process proceeds to step S55.

(S55) The data structure conversion unit 124 stores the value Val at the Row-th row and m-th column in the value array 151 (Sᵥ[Row][m]=Val). In addition, the data structure conversion unit 124 stores the column index Col at the Row-th row and m-th column in the column index array 152 (S_{c}[Row][m]=Col).

(S56) The data structure conversion unit 124 increments the number of non-zero elements m by one.

(S57) The data structure conversion unit 124 determines whether all column indices Col have been selected at step S53 with respect to the row index Row. If all the column indices Col have been selected, the process proceeds to step S58. If any column index Col has not been selected, the process proceeds to step S53.

(S58) The data structure conversion unit 124 determines whether all row indices Row have been selected at step S51. If all the row indices Row have been selected, the generation of the CSR data is completed. If any row index Row has not been selected, the process proceeds to step S51.

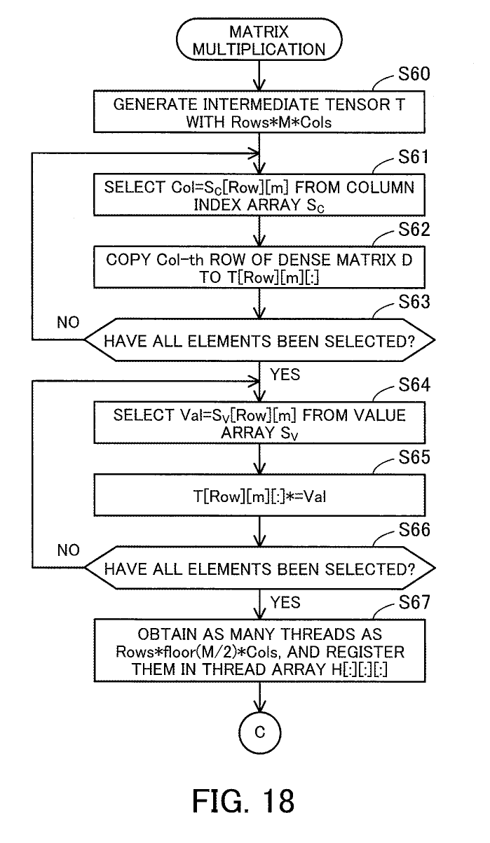

FIG. 18 is a flowchart illustrating an example of the second matrix multiplication.

The second matrix multiplication is performed after the data structure conversion unit 124 generates the second CSR data and the dense matrix generation unit 125 generates the dense matrix 132 in the form of two-dimensional structure data.

(S60) The matrix multiplication unit 126 confirms the number of rows Rows in the value array 151, the number of columns M in the value array 151, and the number of columns Cols in the dense matrix 132. The matrix multiplication unit 126 then generates an intermediate tensor 153 (intermediate tensor T) with size of Rows×M×Cols.

(S61) The matrix multiplication unit 126 selects one of the row indices and one of column indices from the column index array 152 (row index Row and column index m), and extracts an element S_{c}[Row][m] (column index Col) from the Row-th row and m-th column of the column index array 152.

(S62) The matrix multiplication unit 126 copies the Col-th row of the dense matrix 132 (dense matrix D) to the X=Row and Y=m in the intermediate tensor 153 (T[Row][m][:]). In this connection, even if the column index Col identifies a dummy element, its corresponding row is copied in the same way.

(S63) The matrix multiplication unit 126 determines whether all elements have been selected from the column index array 152 at step S61. If all the elements have been selected, the process proceeds to step S64. If any element has not been selected, the process proceeds to step S61. In this connection, steps S61 and S62 may be parallelized using a plurality of threads.

(S64) The matrix multiplication unit 126 selects one of the row indices and one of the column indices from the value array 151 (row index Row and column index m), and extracts an element Sᵥ[Row][m] (value Val) from the Row-th row and m-th column of the value array 151.

(S65) The matrix multiplication unit 126 multiplies each element (T[Row][m][:]) at X=Row, Y=m in the intermediate tensor 153 by the value Val. Even if the extracted element is a dummy element with a value of zero (Val=0), the multiplication is performed in the same way.

(S66) The matrix multiplication unit 126 determines whether all elements have been selected from the value array 151 at step S64. If all the elements have been selected, the process proceeds to step S67. If any element has not been selected, the process proceeds to step S64. In this connection, steps S64 and S65 may be parallelized using a plurality of threads.

(S67) The matrix multiplication unit 126 obtains as many threads as Rows×floor(M/2)×Cols from the thread pool 128. The “Rows” denotes the number of X coordinates in the intermediate tensor 154 (intermediate tensor T) obtained by updating the intermediate tensor 153. The “M” denotes the number of Y coordinates in the intermediate tensor 154. The “Cols” denotes the number of Z coordinates in the intermediate tensor 154. The matrix multiplication unit 126 registers the thread numbers of the obtained threads in the thread array 156 (thread array H) (H[:][:][:]). In the thread array 156, the number of X coordinates is Row, the number of Y coordinates is floor(M/2), and the number of Z coordinates is Cols.

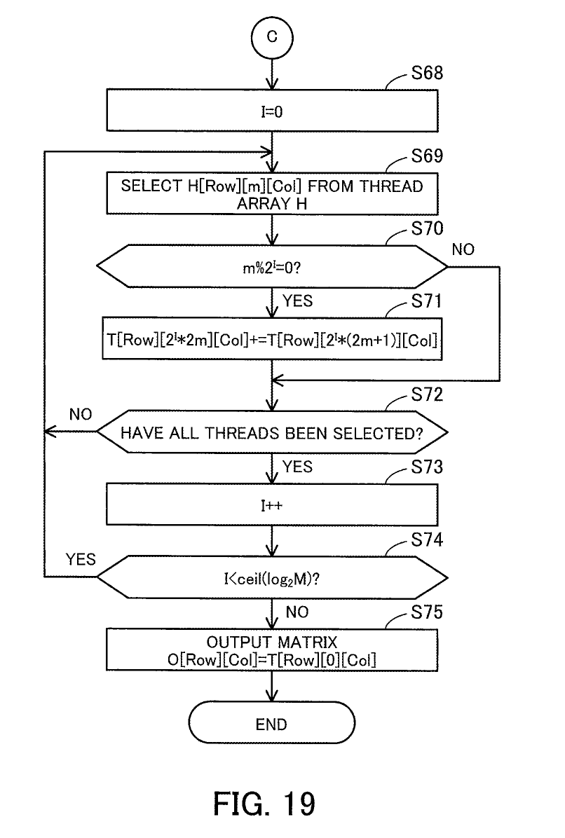

FIG. 19 is a continuation flowchart of the flowchart started in FIG. 18.

(S68) The matrix multiplication unit 126 initializes an iteration count I to zero (i.e., I=0).

(S69) The matrix multiplication unit 126 selects one (H[Row][m][Col]) of the thread numbers in the thread array 156. The location of the selected thread is specified by an X coordinate Row, a Y coordinate m, and a Z coordinate Col. The following steps S70 and S71 are executed using the thread identified by the selected thread number.

(S70) The matrix multiplication unit 126 determines whether a remainder obtained by dividing m by 2^{I} is zero, i.e., whether m % 2^{I}=0 is satisfied. If this condition is satisfied, the process proceeds to step S71. If the condition is not satisfied, the process proceeds to step S72.

(S71) The matrix multiplication unit 126 extracts an element T[Row][2^{I}×2m][Col] and an element T[Row][2^{I}×(2m+1)][Col] from the intermediate tensor 154, and adds the value of the latter element to the former to thereby update the intermediate tensor 154. Even if at least one of the former and latter is a dummy element with a value of zero, the addition operation is performed in the same way.

(S72) The matrix multiplication unit 126 determines whether all thread numbers have been selected from the thread array 156 at step S69. If all the thread numbers have been selected, the process proceeds to step S73. If any thread number has not been selected, the process proceeds to step S69. In this connection, steps S70 and S71 may be parallelized.

(S73) The matrix multiplication unit 126 increments the iteration count I by one.

(S74) The matrix multiplication unit 126 determines whether I<ceil(log₂M) is satisfied, where M denotes the number of Y coordinates in the intermediate tensor 154. If this condition is satisfied, the process proceeds to step S69. If the condition is not satisfied, the process proceeds to step S75.

(S75) The matrix multiplication unit 126 extracts a range of data with Y=0 from the intermediate tensor 154 to thereby produce an output matrix 155 (output matrix O). That is, the matrix multiplication unit 126 takes O[Row][Col]=T[Row][0][Col] with respect to all the X coordinates Row and Z coordinates Col in the intermediate tensor 154.

As described above, in the information processing apparatus 100 of the second embodiment, a large-scale sparse matrix is represented as compressed storage data, and matrix multiplication between the large-scale matrix and a dense matrix is performed, without converting the compressed storage data. This reduces the computation amount for the matrix multiplication, as well as the memory usage. In addition, the matrix multiplication computation is sub-divided into unit operations including data loading, multiplication operations, and addition operations, and a large number of threads are assigned the unit operations and are executed in parallel using a processor including a large number of operating units. Therefore, it is possible to achieve fast matrix multiplication.

Further, in the case of employing the method of the second matrix multiplication, the same number of elements are included in each row of the compressed storage data by inserting dummy elements even if a large-scale sparse matrix contains a different number of non-zero elements in each row. This makes it easy to control assignment of a plurality of threads to subdivided unit operations and to achieve efficient parallel processing. As a result, it is possible to make use of a large number of operating units provided in the processor and to reduce the execution time for matrix multiplication.

According to one aspect, it is possible to parallelize matrix multiplication efficiently.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A matrix computation apparatus comprising:
a memory configured to store therein a program; and
a processor configured to be able to execute a plurality of threads in parallel according to the program,
wherein the processor, when executing the program, performs a process including
counting a number of non-zero elements, whose values are not zero, for each of a plurality of first rows included in a first matrix and determining a maximum value for the number of non-zero elements among the plurality of first rows,
generating compressed storage data containing an equal number of pairs for each of the plurality of first rows by extracting, from each of the plurality of first rows, a pair containing a value of a non-zero element and a column identifier identifying a column to which the non-zero element belongs and adding a dummy pair with a value of zero for each first row that contains fewer non-zero elements than the maximum value,
generating a row vector corresponding to each of the pairs contained in the compressed storage data by extracting, from a second matrix, a second row with a row identifier corresponding to the column identifier included in the each of the pairs and multiplying the extracted second row by the value included in the each of the pairs, and
generating a third matrix representing matrix multiplication between the first matrix and the second matrix by assigning an equal number of threads to each of the plurality of first rows and summing row vectors corresponding to the each of the plurality of first rows using the equal number of threads.

2. The matrix computation apparatus according to claim 1, wherein:
the dummy pair contains the value of zero and a prescribed column identifier; and
the generating of the row vector includes generating a row vector corresponding to the dummy pair.

3. The matrix computation apparatus according to claim 1, wherein the compressed storage data contains as many pairs as the maximum value for each of the plurality of first rows.

4. The matrix computation apparatus according to claim 1, wherein the equal number of threads assigned to each of the plurality of first rows is determined based on the equal number of pairs contained for each of the plurality of first rows in the compressed storage data and a number of columns in the second matrix.

5. The matrix computation apparatus according to claim 1, wherein, upon generating four or more row vectors for each of the plurality of first rows, the summing of the row vectors includes repeatedly summing two row vectors according to a tree structure.

6. A matrix computation method comprising:
counting, by a processor, a number of non-zero elements, whose values are not zero, for each of a plurality of first rows included in a first matrix and determining a maximum value for the number of non-zero elements among the plurality of first rows;
generating, by the processor, compressed storage data containing an equal number of pairs for each of the plurality of first rows by extracting, from each of the plurality of first rows, a pair containing a value of a non-zero element and a column identifier identifying a column to which the non-zero element belongs and adding a dummy pair with a value of zero for each first row that contains fewer non-zero elements than the maximum value;
generating, by the processor, a row vector corresponding to each of the pairs contained in the compressed storage data by extracting, from a second matrix, a second row with a row identifier corresponding to the column identifier included in the each of the pairs and multiplying the extracted second row by the value included in the each of the pairs; and
generating, by the processor, a third matrix representing matrix multiplication between the first matrix and the second matrix by assigning an equal number of threads to each of the plurality of first rows and summing row vectors corresponding to the each of the plurality of first rows using the equal number of threads.

7. A non-transitory computer-readable recording medium storing a program that causes a computer to perform a process comprising:
counting a number of non-zero elements, whose values are not zero, for each of a plurality of first rows included in a first matrix and determining a maximum value for the number of non-zero elements among the plurality of first rows;
generating compressed storage data containing an equal number of pairs for each of the plurality of first rows by extracting, from each of the plurality of first rows, a pair containing a value of a non-zero element and a column identifier identifying a column to which the non-zero element belongs and adding a dummy pair with a value of zero for each first row that contains fewer non-zero elements than the maximum value;
generating a row vector corresponding to each of the pairs contained in the compressed storage data by extracting, from a second matrix, a second row with a row identifier corresponding to the column identifier included in the each of the pairs and multiplying the extracted second row by the value included in the each of the pairs; and
generating a third matrix representing matrix multiplication between the first matrix and the second matrix by assigning an equal number of threads to each of the plurality of first rows and summing row vectors corresponding to the each of the plurality of first rows using the equal number of threads.
